(19) United States
(12) Patent Application Publication
(10) Pub. No.: US 2011/0311885 A1
(43) Pub. Date: Dec. 22, 2011

(54) NONAQUEOUS ELECTROLYTE AND NONAQUEOUS ELECTROLYTE BATTERY

(75) Inventors: Ichiro Yamada, Fukushima (JP); Shunsuke Saito, Fukushima (JP); Haruo Watanabe, Kanagawa (JP); Tadahiko Kubota, Kanagawa (JP)

(73) Assignee: SONY CORPORATION, Tokyo (JP)

(21) Appl. No.: 13/110,110

(22) Filed: May 18, 2011

(30) Foreign Application Priority Data
Jun. 18, 2010 (JP) 2010-139690

(51) Int. Cl. H01M 10/02; H01M 4/60; H01M 4/36

(52) U.S. Cl. 429/338; 429/203; 429/199; 429/202; 429/218.1; 429/213; 429/212

(57) ABSTRACT

A nonaqueous electrolyte includes: a nonaqueous solvent; an electrolyte salt; an imide salt; and at least one of a heteropolyacid and a heteropolyacid compound.

### FIELD

The present disclosure relates to nonaqueous electrolytes and batteries, specifically to nonaqueous electrolytes that contain an organic solvent and an electrolyte salt, and nonaqueous electrolyte batteries using such nonaqueous electrolytes.

### BACKGROUND

There is a strong demand for smaller, lighter, and longer-life portable electronic devices such as camera-integrated VTRs (Video Tape Recorders), cellular phones, and laptop personal computers, which have become pervasive over the last years. In this connection, batteries, particularly secondary batteries, which are light and capable of providing high energy density, have been developed as the portable power source of such electronic devices.

Particularly, secondary batteries (lithium ion secondary batteries) that take advantage of the storage and release of lithium (Li) for the charge and discharge reaction have been put into a wide range of practical applications for their ability to provide higher energy density than other nonaqueous electrolyte secondary batteries such as lead batteries and nickel cadmium batteries. The lithium ion secondary batteries include a positive electrode, a negative electrode, and an electrolyte.

Laminate batteries using an aluminum laminate film for the exterior are light, and thus have particularly high energy density. The laminate polymer battery, as a variation of such laminate batteries, has also been widely used, because the distortion of the laminate battery can be suppressed by the swelling of a polymer with a nonaqueous electrolytic solution.

However, because the laminate battery has a soft exterior, the battery tends to swell with the gas produced inside the battery during the initial charge and high-temperature storage. This problem is addressed in JP-A-2006-86058 (Patent Document 1). In this publication, halogenated cyclic carbonates such as fluoroethylene carbonate, or cyclic carbonates with a C—C multiple bond such as vinylene carbonate are added to the nonaqueous electrolyte to suppress the reaction or other forms of interaction between the negative electrode active material and the nonaqueous electrolyte, and to thus suppress battery swelling during the initial charge. However, these reactive cyclic carbonates cannot suppress battery swelling during high-temperature use, particularly during the continuous charge.

JP-A-2001-297765 (Patent Document 2) describes a high-capacity lithium ion secondary battery that uses an imide salt electrolyte and has excellent charge and discharge cycles.

### SUMMARY

The use of reactive cyclic carbonates as taught in Patent Document 1 cannot suppress battery swelling during high-temperature use, particularly during the continuous charge. The use of an electrolyte with an imide salt as in Patent Document 2 lowers discharge capacity as the imide salt reacts with the negative electrode active material, and is therefore not sufficient to provide sufficient battery characteristics.

Accordingly, there is a need for a nonaqueous electrolyte battery having improved battery characteristics even when used under high-temperature environment.

According to an embodiment of the present disclosure, there is provided a nonaqueous electrolyte that includes a nonaqueous solvent, an electrolyte salt, an imide salt, and at least one of a heteropolyacid and a heteropolyacid compound.

According to another embodiment of the present disclosure, there is provided a nonaqueous electrolyte battery that includes a positive electrode, a negative electrode, and a nonaqueous electrolyte, wherein the positive electrode includes a coating that originates from an imide salt and is formed in at least a portion on a surface of the positive electrode, and wherein the negative electrode includes a gel coating formed in at least a portion on a surface of the negative electrode, the gel coating originating from at least one of a heteropolyacid and a heteropolyacid compound, and including an amorphous polyacid and/or polyacid salt compound that contain one or more polyelements.

It is preferable that the imide salt in the embodiments of the present disclosure be represented by the following formula (I) or (II).

(CₘF₂ₘ₊₁SO₂)(CₙF₂ₙ₊₁SO₂)NLi (I),

where m and n are integers of 0 or more,

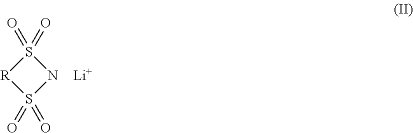

where R represents a linear or branched perfluoroalkylene group of 2 to 4 carbon atoms.

It is preferable that the heteropolyacid and the heteropolyacid compound in the embodiments of the present disclosure be represented by the following formulae (III) to (VI).

HxAy[BD₆O₂₄].zH₂O (III)

wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦8, 0≦y≦8, and 0≦z≦50, respectively, where at least one of x and y is not 0;

HxAy[BD₁₂O₄₀].zH₂O (IV)

wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦4, 0≦y≦4, and 0≦z≦50, respectively, where at least one of x and y is not 0;

HxAy[B₂D₁₈O₆₂].zH₂O (V)

wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦8, 0≦y≦8, and 0≦z≦50, respectively, where at least one of x and y is not 0;

HxAy[B₅D₃₀O₁₁₀].zH₂O (VI)

wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦15, 0≦y≦15, and 0≦z≦50, respectively, where at least one of x and y is not 0.

In the embodiments of the present disclosure, the nonaqueous electrolyte includes an imide salt, and at least one of a heteropolyacid and a heteropolyacid compound. In this way, a coating that originates from the imide salt is formed on the positive electrode, and a coating that originates from the heteropolyacid and heteropolyacid compound is formed on the negative electrode. The reaction between the positive and negative electrodes and the nonaqueous electrolyte can be suppressed with the coatings formed on the positive and negative electrodes. Further, the negative electrode coating can prevent the imide salt from being decomposed in the vicinity of the negative electrode and suppressing the performance of the negative electrode active material.

The embodiments of the present disclosure provide ways to suppress gas production caused by the decomposition of the nonaqueous electrolyte, and battery swelling associated with such gas production. The deterioration of battery characteristics during use under high-temperature environment also can be suppressed.

### BRIEF DESCRIPTION OF THE DRAWINGS

FIG. 1 is a cross sectional view illustrating an exemplary configuration of a nonaqueous electrolyte battery according to an embodiment of the present disclosure.

FIG. 2 is a partially enlarged cross sectional view of a wound electrode unit, illustrated in FIG. 1.

FIG. 3 is a SEM photographic view of a negative electrode surface according to an embodiment of the present disclosure.

FIG. 4 represents an example of a secondary ion spectrum obtained by the time-of-flight secondary ion mass spectrometry (ToF-SIMS) on a negative electrode surface presenting a deposit formed by adding silicotungstic acid to the battery system.

FIG. 5 represents an example of a W—O bond radial structure function obtained by the Fourier transformation of the spectrum from the X-ray absorption fine structure (XAFS) analysis of a negative electrode surface presenting a deposit formed by adding silicotungstic acid to the battery system.

FIG. 6 is an exploded perspective view illustrating an exemplary configuration of a nonaqueous electrolyte battery according to another embodiment of the present disclosure.

FIG. 7 is a cross sectional view of the wound electrode unit of FIG. 6 taken along the line I-I.

FIG. 8 is a cross sectional view representing another exemplary configuration of a nonaqueous electrolyte battery according to an embodiment of the present disclosure.

FIG. 9 is perspective view illustrating another exemplary configuration of a nonaqueous electrolyte battery according to an embodiment of the present disclosure.

### DETAILED DESCRIPTION

The following will describe embodiments of the present disclosure with reference to the accompanying drawings. Descriptions will be given in the following order.

1. First Embodiment (example of a nonaqueous electrolyte that includes an imide salt and a heteropolyacid compound of the present disclosure)

2. Second Embodiment (example using a cylindrical nonaqueous electrolyte battery)

3. Third Embodiment (example using a laminate film-type nonaqueous electrolyte battery)

4. Fourth Embodiment (example using a laminate film-type nonaqueous electrolyte battery)

5. Fifth Embodiment (example using a rectangular nonaqueous electrolyte battery)

6. Sixth Embodiment (example of a nonaqueous electrolyte battery using a laminated electrode unit)

7. Other Embodiments

### 1. First Embodiment

A nonaqueous electrolytic solution according to First Embodiment of the present disclosure is described below. A nonaqueous electrolytic solution according to First Embodiment of the present disclosure is used for electrochemical devices, for example, such as batteries. The nonaqueous electrolytic solution includes a nonaqueous solvent, an electrolyte salt, and both an imide salt and a heteropolyacid compound. The electrolyte salt, the imide salt, and the heteropolyacid compound are dissolved in the solvent.

### (1-1) Imide Salt

The imide salt of the embodiment of the present disclosure is represented by the following formula (I) or (II).

(CₘF₂ₘ₊₁SO₂)(CₙF₂ₙ₊₁SO₂)NLi (I)

In the formula, m and n are integers of 0 or more.

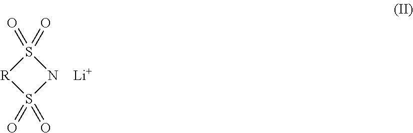

In the formula, R represents a linear or branched perfluoroalkylene group of 2 to 4 carbon atoms.

With the imide salt of formula (I) or (II) contained in the nonaqueous electrolyte, the imide salt anion with the fluoro group is adsorbed on the electrodes, particularly on the positive electrode surface, and a coating is formed. The coating is believed to suppress the reaction between the electrodes and the nonaqueous electrolytic solution particularly under high-temperature environment, and to thereby lower gas production and reduce battery swelling during high-temperature use. The deterioration of battery characteristics during continued use under high-temperature environment also can be prevented.

However, the imide salt is problematic when used alone, because its reactivity to negative electrode active material makes the charge and discharge difficult, and lowers discharge capacity. The co-presence of the heteropolyacid compound (described later) is believed to prevent the movement of lithium ions from being inhibited by the decomposition of the imide salt itself. This is considered to be due to the relatively stable structure of a stable coating called an SEI (Solid Electrolyte Interface) originating from the heteropolyacid compound and formed on the negative electrode by the charge and discharge in initial use, allowing the insertion and desorption of the lithium ions.

Thus, by using the heteropolyacid compound with the imide salt used in a common range, the battery characteristics under high-temperature environment can be improved, without lowering battery capacity and the percentage remaining capacity.

Examples of the chain imide salt represented by formula (I) include lithium bis(fluorosulfonyl)imide, lithium bis(trifluoromethanesulfonyl)imide, lithium bis(pentafluoroethanesulfonyl)imide, lithium bis(heptafluoropropanesulfonyl)imide, lithium bis(nonafluorobutanesulfonyl)imide, lithium(trifluoromethanesulfonyl)(pentafluoroethanesulfonyl)imide, lithium(trifluoromethanesulfonyl)(heptafluoropropanesulfonyl)imide, and lithium(trifluoromethanesulfonyl)(nonafluorobutanesulfonyl)imide.

Examples of the cyclic imide salt represented by formula (II) include perfluoroethane-1,2-disulfonylimide lithium, perfluoropropane-1,3-disulfonylimide lithium, and perfluorobutane-1,4-disulfonylimide lithium.

Two or more compounds selected from the compounds of formula (I) and/or formula (II) can be used in combination.

The imide salt content in the nonaqueous electrolyte is preferably from 0.01 mol/kg to 1.0 mol/kg, inclusive, more preferably from 0.025 mol/kg to 0.2 mol/kg, inclusive. Side reactions cannot be suppressed when the imide salt content is excessively small. An excessively high imide salt content is not preferable, because it lowers battery capacity.

In the embodiment of the present disclosure, more imide salt can be added than in the related art. Adding the imide salt notably improves the battery characteristics under high-temperature environment. However, because the decomposition of the imide salt at the negative electrode lowers discharge capacity, it had been possible to mix the imide salt only in amounts that minimize the problem at the negative electrode. In the embodiment of the present disclosure, on the other hand, the heteropolyacid compound is used together, and thus the imide salt decomposition problem at the negative electrode does not need to be taken into consideration, allowing the imide salt to be added into the battery system in amounts sufficient to provide effects at the positive electrode.

### (1-2) Heteropolyacid and Heteropolyacid Compound

The heteropolyacid and heteropolyacid compound of the embodiment of the present disclosure are formed from heteropolyacids, condensation products of two or more oxoacids. The polyacid ions of the heteropolyacid and heteropolyacid compound preferably have a structure, such as the Anderson structure, Keggin structure, Dawson structure, and Preyssler structure, that easily dissolves in the battery solvent.

The heteropolyacids forming the heteropolyacid and heteropolyacid compound are those including either a polyatom selected from element group (a), or a polyatom selected from element group (a), and in which some of the polyatoms are replaced with at least one selected from element group (b).

Element group (a): Mo, W, Nb, V

Element group (b): Ti, Cr, Mn, Fe, Co, Ni, Cu, Zn, Ga, Zr, Tc, Rh, Cd, In, Sn, Ta, Re, Ti, Pb

Further, the heteropolyacid compound and heteropolyacid are those including either a heteroatom selected from element group (c), or a heteroatom selected from element group (c), and in which some of the heteroatoms are replaced with at least one selected from element group (d).

Element group (c): B, Al, Si, P, Cr, Mn, Fe, Co, Ni, Cu, Zn, Ge, As

Element group (d): H, Be, B, C, Na, Al, Si, P, S, Ti, V, Cr, Mn, Fe, Co, Ni, Cu, Zn, Ga, Ge, As, Se, Zr, Rh, Sn, Sb, Te, I, Re, Pt, Bi, Ce, Th, U, Np

Examples of the heteropolyacid included in the heteropolyacid compound used in the embodiment of the present disclosure include heteropolytungstic acids such as phosphotungstic acid and silicotungstic acid, and heteropolymolybdic acids such as phosphomolybdic acid and silicomolybdic acid. Examples of materials that include more than one polyelement include phosphovanadomolybdic acid, phosphotungstomolybdic acid, silicovanadomolybdic acid, and silicotungstomolybdic acid.

The heteropolyacid compound used in the embodiment of the present disclosure is at least one selected from the compounds of the following formulae (III) to (VI).

### Anderson Structure

HxAy[BD₆O₂₄].zH₂O Formula (III):

In the formula, A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt. B represents phosphorus (P), silicon (Si), arsenic (As), or germanium (Ge). D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl). The variables x, y, and z satisfy 0≦x≦8, 0≦y≦8, and 0≦z≦50, respectively, where at least one of x and y is not 0.

### Keggin Structure

HxAy[BD₁₂O₄₀].zH₂O Formula (IV):

In the formula, A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt. B represents phosphorus (P), silicon (Si), arsenic (As), or germanium (Ge). D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl). The variables x, y, and z satisfy 0≦x≦4, 0≦y≦4, and 0≦z≦50, respectively, where at least one of x and y is not 0.

### Dawson Structure

HxAy[B₂D₁₈O₆₂].zH₂O Formula (V):

In the formula, A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt. B represents phosphorus (P), silicon (Si), arsenic (As), or germanium (Ge). D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl). The variables x, y, and z satisfy 0≦x≦8, 0≦y≦8, and 0≦z≦50, respectively, where at least one of x and y is not 0.

### Preyssler Structure

HxAy[B₅D₃₀O₁₁₀].zH₂O Formula (VI):

In the formula, A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt. B represents phosphorus (P), silicon (Si), arsenic (As), or germanium (Ge). D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl). The variables x, y, and z satisfy 0x≦15, 0≦y≦15, and 0≦z≦50, respectively, where at least one of x and y is not 0.

With the heteropolyacid and/or heteropolyacid compound of formulae (III) to (VI) contained in the nonaqueous electrolyte, a stable coating (SEI) is formed on the electrode surfaces, particularly on the negative electrode surface, by the charge and discharge in initial use. Because the coating originating from the heteropolyacid compound and capable of Li insertion and desorption has excellent Li ion permeability, the coating is believed to lower gas production during high-temperature use while suppressing the reaction between the electrodes and the nonaqueous electrolytic solution, without impairing the cycle characteristics. Further, as described above, the coating is also believed to suppress the reaction between the imide salt and negative electrode active material, and to prevent the movement of lithium ions from being inhibited by the decomposition of the imide salt.

The heteropolyacid compound preferably has a cation, for example, such as Li⁺, Na⁺, K⁺, Rb⁺, Cs⁺, R₄N⁺, and R₄P⁺ (where R is H or a hydrocarbon group of 10 or less carbon atoms). The cation is preferably Li⁺, tetra-n-butylammonium, or tetra-n-butylphosphonium.

Examples of such heteropolyacid compounds include heteropolytungstic acid compounds such as sodium silicotungstate, sodium phosphotungstate, ammonium phosphotungstate, and tetra-tetra-n-butyl phosphonium silicotungstate. Other examples of heteropolyacid compounds include heteropolymolybdic acid compounds such as sodium phosphomolybdate, ammonium phosphomolybdate, and tri-tetra-n-butyl ammonium phosphomolybdate. Examples of compounds that include more than one polyelement include materials such as tri-tetra-n-ammonium phosphotungstomolybdate. The heteropolyacid and heteropolyacid compound may be used as a mixture of two or more. The heteropolyacid and heteropolyacid compound easily dissolve in the solvent, and, because of the stability in the battery, do not easily cause adverse effects, for example, by reacting with other materials.

In the embodiment of the present disclosure, at least one of the polyacid and polyacid compound may be used. The polyacid ions of the polyacid and polyacid compound are preferably of a structure, such as the Anderson structure, Keggin structure, Dawson structure, and Preyssler structure, that easily dissolves in the battery solvent. Aside from the heteropolyacid compound, an isopolyacid compound may be used as the polyacid compound. The isopolyacid compound is not as effective as the heteropolyacid compound per added weight. However, because of low solubility in a polar solvent, the isopolyacid compound, when used for the positive and negative electrodes, provides excellent coating characteristics, including coating viscoelasticity and anti-deterioration property over time, and is therefore useful from the industrial standpoint.

As with the case of the heteropolyacid compound, the polyacid compounds used in the embodiment of the present disclosure are those including either a polyatom selected from element group (a), or a polyatom selected from element group (a), and in which some of the polyatoms are replaced with at least one selected from element group (b).

Element group (a): Mo, W, Nb, V

Element group (b): Ti, Cr, Mn, Fe, Co, Ni, Cu, Zn, Ga, Zr, Tc, Rh, Cd, In, Sn, Ta, Re, Tl, Pb

Examples of the polyacid included in the polyacid compounds used in the embodiment of the present disclosure include tungstic acid(VI), and molybdic acid(VI). Specific examples include tungstic anhydride, molybdenum anhydride, and hydrates of these. Examples of hydrates include ortho-tungstic acids (H₂WO₄), specifically tungstic acid monohydrate (WO₃.H₂O); and ortho-molybdic acids (H₂MoO₄), specifically molybdic acid dihydrates (H₄MoO₅, H₂MoO₄.H₂O, MoO₃.2H₂O), and molybdic acid monohydrate (MoO₃.H₂O). It is also possible to use tungstic anhydride (WO₃) having less, ultimately zero, hydrogen content than isopolyacids of the foregoing hydrates, such as meta-tungstic acid and para-tungstic acid, or molybdenum anhydride (MoO₃) having less, ultimately zero, hydrogen content than meta-molybdic acid, para-molybdic acid, and the like.

The nonaqueous electrolyte includes the heteropolyacids or heteropolyacid compounds of formulae (III) to (VI). Two or more selected from the heteropolyacids or heteropolyacid compounds of formulae (III) to (VI) also can be used in combination. It is particularly preferable to add a heteropolyacid compound of a structure containing no protons or water to the nonaqueous electrolyte, because it makes it possible to control the water content in the nonaqueous electrolytic solution, and to suppress free acid production, regardless of the amount of heteropolyacid compound added.

The contents of the heteropolyacid and heteropolyacid compound in the nonaqueous electrolytic solution are preferably from 0.01 weight % to 3.0 weight %, inclusive, from the standpoint of battery swelling after the initial charge, more preferably from 0.05 weight % to 2.0 weight %, inclusive, from the standpoint of battery swelling after the initial charge and after high-temperature storage. When the heteropolyacid and heteropolyacid compound contents are excessively small, SEI formation becomes insufficient, and it becomes difficult to obtain the effect of adding the heteropolyacid compound. The excess contents are not preferable, because the reaction makes the irreversible capacity too large, and lowers the battery capacity.

### (1-3) Configuration of Nonaqueous Electrolyte Used for Addition of Imide Salt and Heteropolyacid Compound Electrolyte Salt

The electrolyte salt includes, for example, one or more light metal salts such as lithium salts. Examples of lithium salts include lithium hexafluorophosphate (LiPF₆), lithium tetrafluoroborate (LiBF₄), lithium perchloride (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). At least one selected from lithium hexafluorophosphate (LiPF₆), lithium tetrafluoroborate (LiBF₄), lithium perchloride (LiClO₄), and lithium hexafluoroarsenate (LiAsF₆) is preferable, of which lithium hexafluorophosphate (LiPF₆) is more preferable. These are preferable for their ability to lower the resistance of the nonaqueous electrolyte. Use of lithium hexafluorophosphate (LiPF₆) with lithium tetrafluoroborate (LiBF₄) is particularly preferred, because it provides strong effects.

### Nonaqueous Solvent

Examples of nonaqueous solvent include ethylene carbonate (EC), propylene carbonate (PC), butylene carbonate (BC), dimethyl carbonate (DMC), diethyl carbonate (DEC), ethylmethyl carbonate (EMC), methylpropyl carbonate (MPC), γ-butyrolactone, y-valerolactone, 1,2-dimethoxyethane, tetrahydrofuran, 2-methyltetrahydrofuran, tetrahydropyran, 1,3-dioxolan, 4-methyl-1,3-dioxolan, 1,3-dioxane, 1,4-dioxane, methyl acetate, ethyl acetate, methyl propionate, ethyl propionate, methyl butyrate, isomethyl butyrate, trimethylmethyl acetate, trimethylethyl acetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. These provide excellent capacity, excellent cycle characteristics, and excellent storage characteristics in batteries and other electrochemical devices that use nonaqueous electrolytes. These may be used either alone, or as a mixture of two or more.

Preferably, the solvent used includes at least one selected from ethylene carbonate (EC), propylene carbonate (PC), dimethyl carbonate (DMC), diethyl carbonate (DEC), and ethylmethyl carbonate (EMC). These are preferable for their ability to provide sufficient effects. In this case, it is preferable to use a high-viscosity (high-dielectric) solvent (for example, relative permittivity ∈≧30), for example, such as ethylene carbonate and propylene carbonate, as a mixture with a low-viscosity solvent (for example, viscosity ≦1 mPa·s), for example, such as dimethyl carbonate, diethyl carbonate, and ethylmethyl carbonate. The use of such mixtures improves the dissociation of the electrolyte salt and ion mobility, and thus provides stronger effects.

The nonaqueous solvent may contain cyclic carbonate represented by the following formula (VII) or (VIII). Two or more selected from the compounds of formulae (VII) and (VIII) may be used in combination.

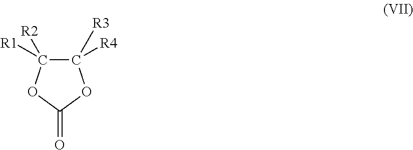

In the formula, R1 to R4 are hydrogen groups, halogen groups, alkyl groups, or halogenated alkyl group, and at least one of R1 to R4 is a halogen group or a halogenated alkyl group.

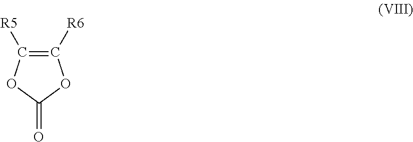

In the formula, R5 and R6 are hydrogen groups or alkyl groups.

Examples of halogen-containing cyclic carbonate esters represented by formula (VII) include 4-fluoro-1,3-dioxolan-2-one, 4-chloro-1,3-dioxolan-2-one, 4,5-difluoro-1,3-dioxolan-2-one, tetrafluoro-1,3-dioxolan-2-one, 4-chloro-5-fluoro-1,3-dioxolan-2-one, 4,5-dichloro-1,3-oxolan-2-one, tetrachloro-1,3-dioxolan-2-one, 4,5-bistrifluoromethyl-1,3-dioxolan-2-one, 4-trifluoromethyl-1,3-dioxolan-2-one, 4,5-difluoro-4,5-dimethyl-1,3-dioxolan-2-one, 4,4-difluoro-5-methyl-1,3-dioxolan-2-one, 4-ethyl-5,5-difluoro-1,3-dioxolan-2-one, 4-fluoro-5-trifluoromethyl-1,3-dioxolan-2-one, 4-methyl-5-trifluoromethyl-1,3-dioxolan-2-one, 4-fluoro-4,5-dimethyl-1,3-dioxolan-2-one, 5-(1,1-difluoroethyl)-4,4-difluoro-1,3-dioxolan-2-one, 4,5-dichloro-4,5-dimethyl-1,3-dioxolan-2-one, 4-ethyl-5-fluoro-1,3-dioxolan-2-one, 4-ethyl-4,5-difluoro-1,3-dioxolan-2-one, 4-ethyl-4,5,5-trifluoro-1,3-dioxolan-2-one, and 4-fluoro-4-methyl-1,3-dioxolan-2-one. These may be used either alone, or as a mixture of two or more. Of these, 4-fluoro-1,3-dioxolan-2-one and 4,5-difluoro-1,3-dioxolan-2-one are preferable, because these are readily available, and can provide strong effects.

Examples of unsaturated bond-containing cyclic carbonate esters represented by formula (VIII) include vinylene carbonate (1,3-dioxole-2-one), methylvinylene carbonate (4-methyl-1,3-dioxole-2-one), ethylvinylene carbonate (4-ethyl-1,3-dioxole-2-one), 4,5-dimethyl-1,3-dioxole-2-one, 4,5-diethyl-1,3-dioxole-2-one, 4-fluoro-1,3-dioxole-2-one, and 4-trifluoromethyl-1,3-dioxole-2-one. These may be used either alone, or as a mixture of two or more. Of these, vinylene carbonate is preferred, because it is readily available, and can provide strong effects.

### Polymer Compound

In the embodiment of the present disclosure, the nonaqueous electrolyte as a mixture of the nonaqueous solvent and the electrolyte salt may exist in a gel state with a polymer compound-containing retainer.

Materials that gel by absorbing the solvent can be used as the polymer compound. Examples include fluoro polymer compounds such as a copolymer of polyvinylidene fluoride or vinylidene fluoride with hexafluoropropylene; ether polymer compounds such as a crosslinked product including polyethylene oxide or polyethylene oxide; and compounds including repeating units of polyacrylonitrile, polypropylene oxide, or polymethylmethacrylate. The polymer compounds may be used either alone, or as a mixture of two or more.

From the standpoint of redox stability, fluoro polymer compounds are particularly preferable, of which copolymers containing vinylidene fluoride and hexafluoropropylene components are preferred. For improved characteristics, the copolymer may also include monoesters of unsaturated diacids such as monomethyl maleate acid; halogenated ethylene such as chlorotrifluoroethylene; cyclic carbonate esters of unsaturated compounds such as vinylene carbonate; or an epoxy group-containing acrylvinyl monomer.

The method of forming a gel electrolyte layer will be described later.

### Advantages

In First Embodiment of the present disclosure, at least one of the imide salts represented by formulae (I) and (II), and at least one of the heteropolyacids and heteropolyacid compounds represented by formulae (III) to (VI) are contained in the nonaqueous electrolyte. In this way, the reaction between the electrodes and the nonaqueous electrolytic solution can be suppressed to reduce gas production, and to thus reduce battery swelling during high-temperature use.

### 2. Second Embodiment

A nonaqueous electrolyte battery according to Second Embodiment of the present disclosure is described below. The nonaqueous electrolyte battery of Second Embodiment is a cylindrical nonaqueous electrolyte battery.

### (2-1) Configuration of Nonaqueous Electrolyte Battery

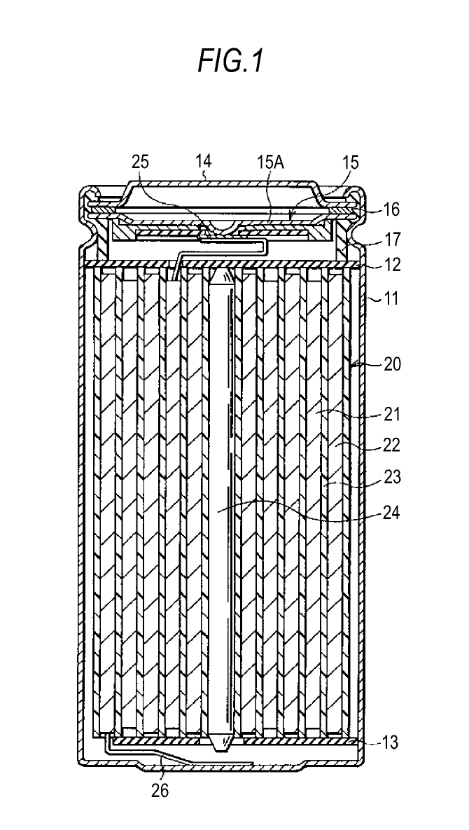

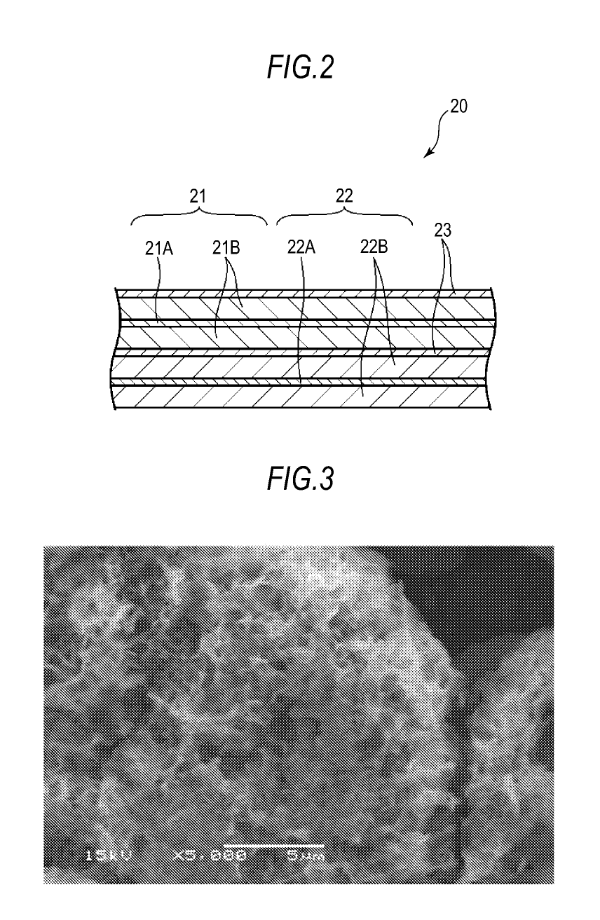

FIG. 1 illustrates the cross sectional configuration of the nonaqueous electrolyte battery of Second Embodiment. FIG. 2 is a partial magnified view of a wound electrode unit 20 shown in FIG. 1. The nonaqueous electrolyte battery is a lithium ion secondary battery in which, for example, the negative electrode capacity is represented based on the storage and release of the electrode reaction substance lithium.

### Overall Configuration of Nonaqueous Electrolyte Battery

The nonaqueous electrolyte battery is structured to include primarily a substantially hollow cylindrical battery canister 11, a wound electrode unit 20 including a positive electrode 21 and a negative electrode 22 wound around with a separator 23 laminated in between, and a pair of insulating plates 12 and 13. The wound electrode unit 20 and the insulating plates 12 and 13 are housed inside the cylindrical battery canister 11. The battery structure using such a cylindrical battery canister 11 is called a cylindrical structure.

The battery canister 11 is made of, for example, nickel (Ni)-plated iron (Fe), and has a closed end and an open end. Inside the battery canister 11, the insulating plates 12 and 13 are disposed on the both sides of the wound electrode unit 20, perpendicularly to the rolled surface.

The battery canister 11 is sealed with a battery lid 14 fastened to the open end of the battery canister 11 by swaging via a gasket 17, together with a safety valve mechanism 15 and a heat-sensitive resistive element (PTC: Positive Temperature Coefficient) 16 provided inside the battery lid 14.

The battery lid 14 is formed using, for example, the same or similar materials used for the battery canister 11. The safety valve mechanism 15 is electrically connected to the battery lid 14 via the heat-sensitive resistive element 16, and cuts off the electrical connection between the battery lid 14 and the wound electrode unit 20 by the inversion of a disk plate 15A, when the pressure inside the battery reaches a certain level as a result of internal shorting or external heat.

The heat-sensitive resistive element 16 increases its resistance value under elevated temperatures, and restricts current to prevent abnormal heating due to overcurrent. The gasket 17 is formed using, for example, insulating material, and is asphalt-coated.

A center pin 24 is inserted at, for example, the center of the wound electrode unit 20. The positive electrode 21 of the wound electrode unit 20 is connected to a positive electrode lead 25 of, for example, aluminum (Al), and the negative electrode 22 is connected to a negative electrode lead 26 of, for example, nickel (Ni). The positive electrode lead 25 is electrically connected to the battery lid 14 by being welded to the safety valve mechanism 15. The negative electrode lead 26 is electrically connected to the battery canister 11 by being welded thereto.

### Positive Electrode

The positive electrode 21 is structured to include, for example, a positive electrode active material layer 21B provided on the both sides of a positive electrode collector 21A having a pair of faces. The positive electrode active material layer 21B may be provided only on one side of the positive electrode collector 21A. A coating that originates from at least one of the imide salts represented by formulae (I) and (II) is formed on the positive electrode surface. Note that the deposit formed on the positive electrode forms according to the amount of the imide salt added to the battery system.

The positive electrode collector 21A is configured from metallic material, for example, such as aluminum, nickel, and stainless steel.

The positive electrode active material layer 21B includes positive electrode active material, which is one or more positive electrode materials capable of storing and releasing lithium. Other materials such as a binder and a conductive agent also may be contained, as required.

Preferred examples of the positive electrode material that can store and release lithium include lithium-containing compounds, for their ability to provide high energy density. Examples of lithium-containing compounds include composite oxides that include lithium and transition metal elements; and phosphoric acid compounds that include lithium and transition metal elements. Of these, compounds including at least one transition metal element selected from cobalt, nickel, manganese, and iron are preferred for their ability to provide high voltage.

Examples of composite oxides that include lithium and transition metal elements include lithium cobalt composite oxide (LiₓCoO₂), lithium nickel composite oxide (LiₓNiO₂), lithium nickel cobalt composite oxide (LiₓNi_{1-z}CO_{z}O₂ (z<1)), lithium nickel cobalt manganese composite oxide (LiₓNi_{(1-v-w)}COᵥMn_{w}O₂ (v+w<1)), and lithium manganese composite oxide (LiMn₂O₄) or lithium manganese nickel composite oxide (LiMn₂₋ₜNiₜO₄ (t<2)) of a spinel-type structure. Of these, cobalt-containing composite oxides are preferred for their ability to provide high capacity and excellent cycle characteristics. Examples of phosphoric acid compounds that include lithium and transition metal elements include lithium iron phosphate compounds (LiFePO₄), and lithium iron manganese phosphate compounds (LiFe₁₋ᵤMnᵤPO₄ (u<1)).

Further, from the standpoint of providing even higher electrode chargeability and cycle characteristics, composite particles may be used that are produced by coating the surface of the core particles of any of the foregoing lithium-containing compounds with fine particles of other lithium-containing compounds.

Other examples of the positive electrode material that can store and release lithium include: oxides such as titanium oxide, vanadium oxide, and manganese dioxide; disulfides such as titanium disulfide and molybdenum sulfide; chalcogenides such as niobium selenide; sulfur; and conductive polymers such as polyaniline and polythiophene. The positive electrode material that can store and release lithium may be other than these examples. Further, positive electrode materials such as those exemplified above may be used as a mixture of any combination of two or more.

### Negative Electrode

The negative electrode 22 is structured to include, for example, a negative electrode active material layer 22B provided on the both sides of a negative electrode collector 22A having a pair of faces. The negative electrode active material layer 22B may be provided only on one side of the negative electrode collector 22A. A coating that originates from at least one of the heteropolyacids and heteropolyacid compounds represented by formulae (III) to (VI) is formed on the negative electrode surface. The coating includes a deposit of a three-dimensional mesh structure formed by the electrolysis of the heteropolyacid compound in response to preliminary charging or charging. The coating is formed on at least a portion of the negative electrode surface, and includes an amorphous polyacid and/or polyacid compound that contain one or more polyelements. The amorphous polyacid and/or polyacid compound exists in a gel state with the nonaqueous electrolytic solution.

The gel coating of the embodiment of the present disclosure formed on the negative electrode surface and including an amorphous polyacid and/or polyacid compound of one or more polyacid elements can be observed with a SEM (Scanning Electron Microscope), for example, as shown in FIG. 3. Note that FIG. 3 is a SEM image of the negative electrode surface after charging, taken after removing the nonaqueous electrolytic solution by washing, followed by drying.

The presence or absence of the deposition of the amorphous polyacid and/or polyacid compound can be confirmed based on the structure analysis performed by the X-ray absorption fine structure (XAFS) analysis of the coating formed on the negative electrode surface, and from the chemical information of molecules obtained by time-of-flight secondary ion mass spectrometry (ToF-SIMS).

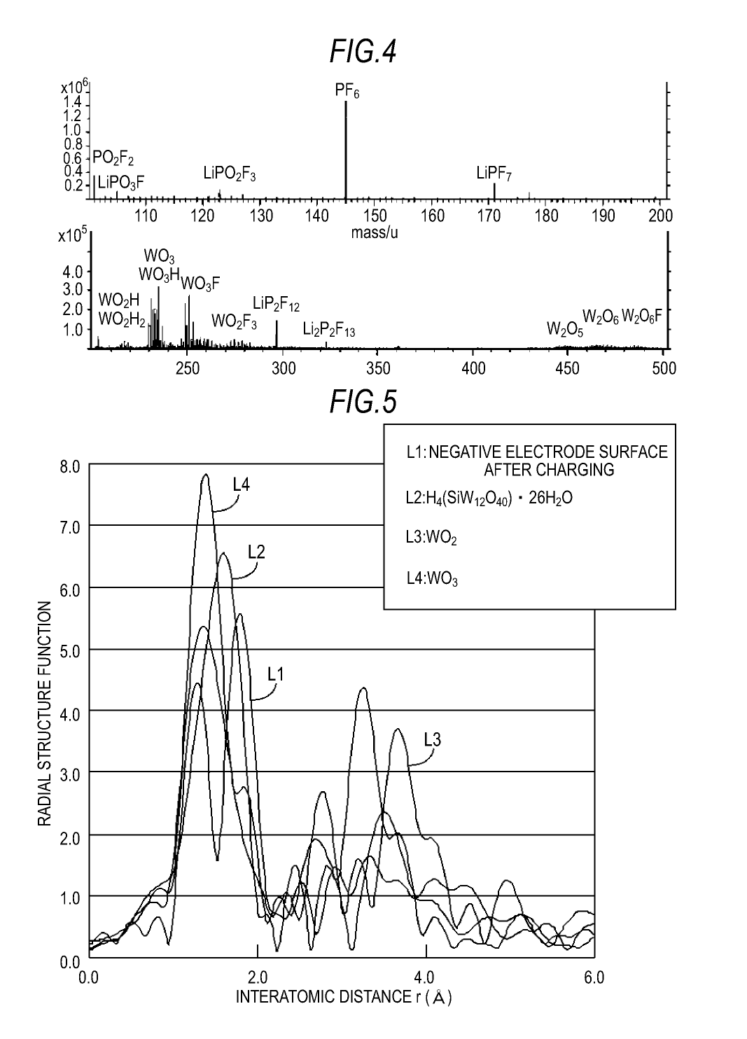

FIG. 4 represents an example of a secondary ion spectrum obtained by the time-of-flight secondary ion mass spectrometry (ToF-SIMS) of the negative electrode surface of a nonaqueous electrolyte battery that includes the negative electrode coating of the embodiment of the present disclosure formed by charging the battery after adding silicotungstic acid to the battery system. As can be seen in FIG. 4, molecules that contain tungsten (W) and oxygen (O) as the constituting elements are present.

FIG. 5 represents an example of a W—O bond radial structure function obtained by the Fourier transformation of the spectrum from the X-ray absorption fine structure (XAFS) analysis of the negative electrode surface of a nonaqueous electrolyte battery that includes a negative electrode coating of the embodiment of the present disclosure formed by charging the battery after adding silicotungstic acid to the battery system. Along with the analysis result of the negative electrode coating, FIG. 5 also represents an example of radial structure functions for the W—O bonds of tungstic acid (WO₃, WO₂) and silicotungstic acid (H₄(SiW₁₂O₄₀).26H₂O) usable as the polyacid and heteropolyacid, respectively, of the embodiment of the present disclosure.

It can be seen from FIG. 5 that the peak L1 of the deposit on the negative electrode surface occurs at a different position from the peaks L2, L3, and L4 of the silicotungstic acid (H₄ (SiW₁₂O₄₀).26H₂O), tungsten dioxide (WO₂), and tungsten trioxide (WO₃), showing that the deposits have different structures. It can be confirmed from the radial structure functions that the main peaks are present in the 1.0 to 2.0 Å range, and other peaks in the 2.0 to 4.0 Å range in the typical tungsten oxides tungsten trioxide (WO₃) and tungsten dioxide (WO₂), and in the starting substance silicotungstic acid (H₄(SiW₁₂O₄₀).26H₂O) of the embodiment of the present disclosure.

On the other hand, the W—O bond distance distribution of the polyacid containing the main component tungstic acid and deposited on the positive and negative electrodes in the embodiment of the present disclosure does not have a distinct peak comparative to peak L1 outside the 1.0 to 2.0 Å range, though peaks occur in this range. Specifically, substantially no peak is observed above 3.0 Å. The result thus confirms that the deposit on the negative electrode surface is indeed amorphous.

The negative electrode collector 22A is configured from metallic material, for example, such as copper, nickel, and stainless steel.

The negative electrode active material layer 22B includes a negative electrode active material, which may be one or more negative electrode materials capable of storing and releasing lithium. Other materials such as a binder and a conductive agent also may be contained, as required. The chargeable capacity of the negative electrode material that can store and release lithium is preferably greater than the discharge capacity of the positive electrode. Note that the specifics of the binder and the conductive agent are as described in conjunction with the positive electrode.

The negative electrode material that can store and release lithium may be, for example, carbon material. Examples of carbon material include easily graphitizable carbon, non-graphitizable carbon having a (002) plane distance of 0.37 nm or more, and graphite having a (002) plane distance of 0.34 nm or less. Specific examples include pyrolyzed carbons, cokes, glass-like carbon fibers, organic polymer compound calcined products, activated carbons, and carbon blacks. Cokes include pitch cokes, needle cokes, and petroleum cokes. The organic polymer compound calcined products refer to carbonized products obtained by calcining phenol resin, furan resin, or the like at appropriate temperatures. Carbon materials are preferred because they undergo a very few changes in crystal structure in the storage and release of lithium, and thus provide high energy density and excellent cycle characteristics, in addition to serving as conductive agents. The carbon material may be fibrous, spherical, granular, or scale-like in shape.

Aside from the carbon material, the negative electrode material that can store and release lithium may be, for example, material that, in addition to being capable of storing and releasing lithium, includes at least one of a metallic element and a semi-metallic element as the constituting element, because such materials also provide high energy density. Such negative electrode materials may include a metallic element or a semi-metallic element either alone or as an alloy or a compound, or may at least partially include one or more phases of these. As used herein, the “alloy” encompasses an alloy or two or more metallic elements, and an alloy of one or more metallic elements and one or more semi-metallic elements. Further, the “alloy” may include a non-metallic element. The composition may be a solid solution, a eutectic (eutectic mixture), or an intermetallic compound, or a mixture of two or more of these.

The metallic and semi-metallic elements are, for example, those capable of forming an alloy with lithium. Specific examples include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn),hafnium (Hf), zirconium (Zr),yttrium (Y), palladium (Pd), and platinum (Pt). At least one of silicon and tin is preferable, and silicon is mote preferable, because these elements are highly capable of storing and releasing lithium, and can provide high energy density.

Examples of negative electrode material that includes at least one of silicon and tin include silicon, either alone or as an alloy or a compound, tin, either alone or as an alloy or a compound, and materials that at least partially include one or more phases of these.

Examples of silicon alloy include those including at least one non-silicon second constituting element selected from tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). Examples of tin alloy include those including at least one non-tin (Sn) second constituting element selected from silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr).

Examples of tin compound and silicon compound include those containing, for example, oxygen (O) or carbon (C). The tin compound and the silicon compound may optionally include the second constituting elements exemplified above, in addition to tin (Sn) or silicon (Si).

Particularly preferred as the negative electrode material that includes at least one of silicon (Si) and tin (Sn) is, for example, a material that includes tin (Sn) as a first constituting element, and a second and a third constituting element in addition to first constituting element tin (Sn). The negative electrode material may be used together with the negative electrode materials exemplified above. The second constituting element is at least one selected from cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum(Mo), silver (Ag), indium (In), cerium(Ce),hafnium (Hf), tantalum (Ta), tungsten (W), bismuth (Bi), and silicon (Si). The third constituting element is at least one selected from boron (B), carbon (C), aluminum (Al), and phosphorus (P). Inclusion of the second and third elements improves cycle characteristics.

A CoSnC-containing material is particularly preferable that includes tin (Sn), cobalt (Co), and carbon (C) as the constituting elements, and in which the carbon (C) content ranges from 9.9 mass % to 29.7 mass %, inclusive, and in which the proportion of cobalt (Co) in the total of tin (Sn) and cobalt (Co) (Co/(Sn+Co)) ranges from 30 mass % to 70 mass %, inclusive. High energy density and excellent cycle characteristics can be obtained with these composition ranges.

The SnCoC-containing material may optionally include other constituting elements, as required. Preferred examples of other constituting elements include silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), and bismuth (Bi), which may be contained in combinations of two or more. Inclusion of these elements further improves capacity characteristics or cycle characteristics.

It is preferable that the SnCoC-containing material include a tin (Sn)-, cobalt (Co)-, and carbon (C)-containing phase, and that this phase have a low-crystalline or amorphous structure. Further, in the SnCoC-containing material, it is preferable that the constituting element carbon at least partially bind to the other constituting elements, namely, metallic elements or semi-metallic elements. Bonding of the carbon with other elements suppresses agglomeration or crystallization of tin (Sn) or other elements, which is considered to lower cycle characteristics.

The state of element binding can be measured by, for example, X-ray photoelectron spectroscopy (XPS). In XPS, the peak of the carbon 1s orbital (C1s) appears at 284.5 eV for graphite, when the device used is calibrated to provide a peak of the gold atom 4f orbital (Au4f) at 84.0 eV. The peak appears at 284.8 eV in surface-contaminated carbon. In contrast, when the carbon element charge density is high as in, for example, the carbon binding to a metallic element or a semi-metallic element, the C1s peak appears in a region below 284.5 eV. That is, when the C1s synthetic wave peak for SnCoC-containing material appears in a region below 284.5 eV, the carbon (C) contained in the SnCoC-containing material is at least partially binding to the other constituting elements, namely, the metallic element or the semi-metallic element.

Note that XPS uses, for example, a C1s peak for the calibration of the spectral energy axis. Generally, because the surface-contaminated carbon is present on the surface, the C1s peak of the surface-contaminated carbon is set to 284.8 eV, and used as the reference energy. In XPS, because the waveform of the C1s peak is obtained as the waveform that contains the peak of the surface-contaminated carbon and the peak of the carbon contained in the SnCoC-containing material, the peak of the surface-contaminated carbon and the peak of the carbon contained in the SnCoC-containing material are separated using, for example, commercially available software. In the waveform analysis, the position of the main peak on the lowest binding energy side is used as the reference energy (284.8 eV).

Other examples of the negative electrode material that can store and release lithium include metal oxides and polymer compounds that are capable of storing and releasing lithium. Examples of such metal oxides include iron oxide, ruthenium oxide, and molybdenum oxide. Examples of such polymer compounds include polyacetylene, polyaniline, and polypyrrole.

The negative electrode material that can store and release lithium may be other than these examples. Further, negative electrode materials such as those exemplified above may be used as a mixture of any combination of two or more.

The negative electrode active material layer 22B may be formed using, for example, any of a vapor-phase method, a liquid-phase method, a spray method, a calcining method, and coating, either individually or in combinations of two or more. When forming the negative electrode active material layer 22B using a vapor-phase method, a liquid-phase method, a spray method, or a calcining method, either individually or in combinations of two or more, it is preferable that an alloy be formed at least a portion of the interface between the negative electrode active material layer 22B and the negative electrode collector 22A. Specifically, it is preferable that the constituting elements of the negative electrode collector 22A diffuse into the negative electrode active material layer 22B at the interface, or the constituting elements of the negative electrode active material layer 22B diffuse into the negative electrode collector 22A at the interface. Further, these constituting elements preferably diffuse into the other layer between the negative electrode collector 22A and the negative electrode active material layer 22B. In this way, destruction caused by the expansion and contraction of the negative electrode active material layer 22B due to charge and discharge can be suppressed, and the electron conductivity between the negative electrode active material layer 22B and the negative electrode collector 22A can be improved.

The vapor-phase method may be, for example, a physical deposition method or a chemical deposition method, specifically, a vacuum deposition method, a sputter method, an ion plating method, a laser abrasion method, a chemical vapor deposition (CVD) method, or a plasma chemical vapor deposition method. Known techniques such as electroplating and non-electrolytic plating can be used as the liquid-phase method. The calcining method is a method in which, for example, a particulate negative electrode active material is mixed with other components such as a binder, dispersed in a solvent, and coated before it is subjected to a heat treatment at a temperature higher than the melting point of, for example, the binder. The calcining method also can be performed using known techniques, for example, such as an atmosphere calcining method, a reactive calcining method, and a hot-press calcining method.

### Separator

The separator 23 is provided to isolate the positive electrode 21 and the negative electrode 22 from each other, and allows for passage of lithium ions while preventing current shorting caused by contacting of the electrodes. The separator 23 is configured using, for example, a porous film of synthetic resin such as polytetrafluoroethylene, polypropylene, and polyethylene, or a ceramic porous film. The separator 23 may be a laminate of two or more of these porous films. The separator 23 is impregnated with the nonaqueous electrolytic solution of First Embodiment described above.

### (2-2) Producing Method of Nonaqueous Electrolyte Battery

The nonaqueous electrolyte battery can be produced as follows.

### Production of Positive Electrode

The fabrication begins with the positive electrode 21. For example, the positive electrode material, the binder, and the conductive agent are mixed to obtain a positive electrode mixture, which is then dispersed in an organic solvent, and formed into a paste positive electrode mixture slurry. The positive electrode mixture slurry is then evenly coated over the both surfaces of the positive electrode collector 21A using, for example, a doctor blade or a bar coater. After drying, the coating is compression molded using, for example, a roller press machine under optionally applied heat, and the positive electrode active material layer 21B is formed. The compression molding may be repeated multiple times.

### Production of Negative Electrode

The negative electrode 22 is fabricated next. For example, the negative electrode material, the binder, and, optionally, the conductive agent are mixed to obtain a negative electrode mixture, which is then dispersed in an organic solvent, and formed into a paste negative electrode mixture slurry. The negative electrode mixture slurry is evenly coated over the both surfaces of the negative electrode collector 22A using, for example, a doctor blade or a bar coater. After drying, the coating is compression molded using, for example, a roller press machine under optionally applied heat, and the negative electrode active material layer 22B is formed.

### Assembly of Nonaqueous Electrolyte Battery

The positive electrode lead 25 and the negative electrode lead 26 are attached to the positive electrode collector 21A and to the negative electrode collector 22A, respectively, by, for example, welding. The positive electrode 21 and the negative electrode 22 are then wound around via the separator 23, and the positive electrode lead 25 and the negative electrode lead 26 are welded at the front end to the safety valve mechanism 15 and to the battery canister 11, respectively. The roll of the positive electrode 21 and the negative electrode 22 is then sandwiched between the insulating plates 12 and 13, and housed inside the battery canister 11. With the positive electrode 21 and the negative electrode 22 housed inside the battery canister 11, the nonaqueous electrolytic solution of First Embodiment is injected into the battery canister 11, and the separator 23 is impregnated with the electrolytic solution. The battery lid 14, the safety valve mechanism 15, and the heat-sensitive resistive element 16 are then fastened to the pen end of the battery canister 11 by swaging via the gasket 17. As a result, the nonaqueous electrolyte battery shown in FIGS. 2 and 3 is obtained.

In the nonaqueous electrolyte battery configured as above, the anions of the imide salt of formula (I) or (II) contained in the nonaqueous electrolytic solution are adsorbed on the positive electrode surface at the time of initial charging. As a result, the reaction between the electrodes and the nonaqueous electrolytic solution is suppressed, and gas production particularly during high-temperature use is reduced.

Further, at least one of the heteropolyacids and heteropolyacid compounds of formulae (III) to (VI) undergoes electrolysis and deposits to form a coating on the negative electrode surface. The heteropolyacid compound of any of formulae (III) to (VI) is capable of the insertion and desorption of lithium ions, and thus by being contained in the nonaqueous electrolytic solution, the heteropolyacid compound forms a stable SEI coating on the negative electrode in response to the charge and discharge in initial use, and suppresses the decomposition of the solvent and the electrolyte salt in the nonaqueous electrolytic solution. The SEI formed by the heteropolyacid and/or heteropolyacid compound is inorganic and strong, and has a small resistance for the insertion and desorption of lithium ions. It is therefore considered that the SEI is unlikely to cause adverse effects such as capacity deterioration. Further, the monofluorophosphate and/or difluorophosphate, similar to the lithium salt in the nonaqueous electrolytic solution, added with the heteropolyacid and/or heteropolyacid compound are considered to further suppress the decomposition of the electrolyte salt, and form a low-resistant SEI.

The nonaqueous electrolytic solution of the embodiment of the present disclosure impregnates the negative electrode active material layer 22B, and thus a compound that originates from at least one of the heteropolyacids and heteropolyacid compounds of formulae (III) to (VI) may deposit in the negative electrode active material layer 22B in response to charging or preliminary charging. Specifically, a compound that originates from at least one of the heteropolyacids and heteropolyacid compounds of formulae (III) to (VI) may be present between the negative electrode active material particles.

Similarly, because the nonaqueous electrolytic solution impregnates the positive electrode active material layer 21B, a compound that originates from at least one of the heteropolyacids and heteropolyacid compounds of formulae (III) to (VI) may deposit in the positive electrode active material layer 21B in response to charging or preliminary charging. That is, a compound that originates from at least one of the heteropolyacids and heteropolyacid compounds of formulae (III) to (VI) may be present between the positive electrode active material particles.

The presence or absence of the compound that originates from at least one of the heteropolyacids and heteropolyacid compounds of formulae (III) to (VI) in the negative electrode coating can be confirmed by, for example, X-ray photoemission spectroscopy (XPS) analysis or time-of-flight secondary ion mass spectrometry (ToF-SIMS). In this case, the battery is washed with dimethyl carbonate after disassembling the battery. The battery is washed to remove the low volatile solvent component and the electrolyte salt present on the surface. Preferably, sampling is performed in an inert atmosphere as much as possible.

### Advantages

In Second Embodiment of the present disclosure, a nonaqueous electrolyte battery is used that contains at least one of the imide salts of formulae (I) and (II), and at least one of the heteropolyacids and heteropolyacid compounds of formulae (III) to (VI) in the nonaqueous electrolyte. In this way, the deterioration of battery characteristics under high-temperature environment can be suppressed, and the side reaction of the electrode active material and the nonaqueous electrolytic solution can be suppressed during continued use. As a result, the battery characteristics improve. Because the addition of the imide salt and heteropolyacid compound in the present disclosure is also effective for use under high-temperature environment, the present disclosure is applicable to both primary and secondary batteries. Preferably, the present disclosure is used for secondary batteries, because the present disclosure is more effective in batteries with many charge and discharge cycles.

### 3. Third Embodiment

A nonaqueous electrolyte battery according to Third Embodiment of the present disclosure is described below. The nonaqueous electrolyte battery of Third Embodiment is a laminate film-type nonaqueous electrolyte battery with the laminate film exterior.

### (3-1) Configuration of Nonaqueous Electrolyte Battery

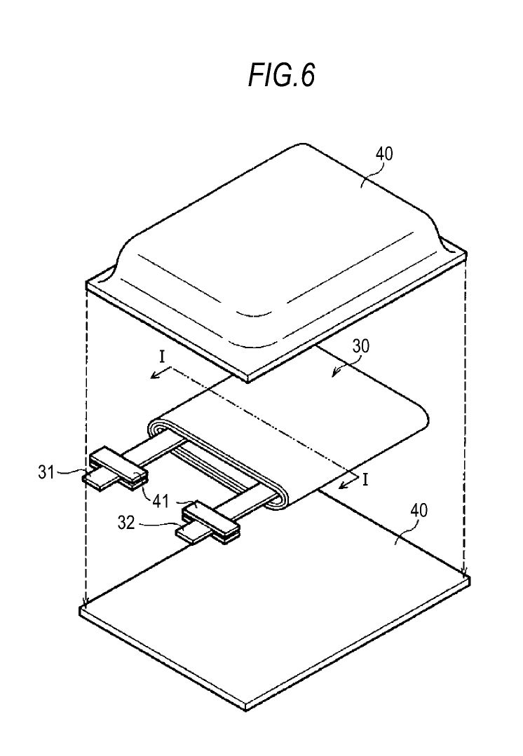

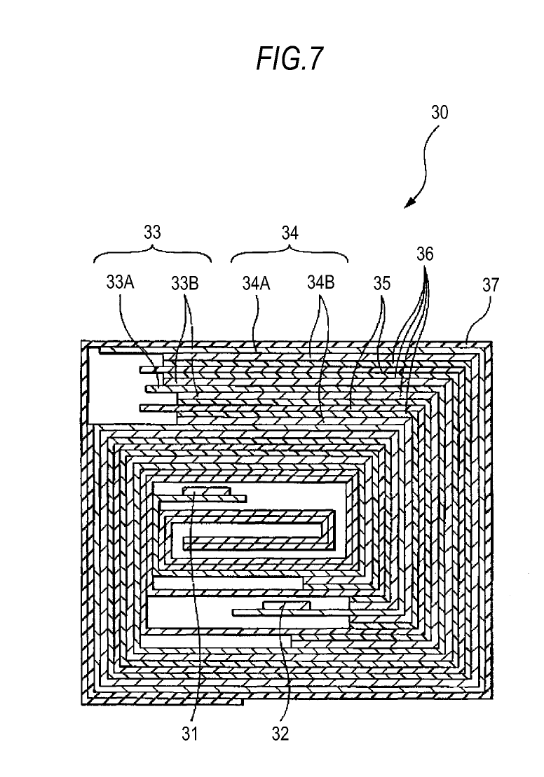

A nonaqueous electrolyte battery according to Third Embodiment of the present disclosure is described. FIG. 6 is an exploded perspective view representing a configuration of the nonaqueous electrolyte battery according to Third Embodiment of the present disclosure. FIG. 7 is a magnified cross sectional view of a wound electrode unit 30 of FIG. 6 at the line I-I.

The nonaqueous electrolyte battery is basically structured to include a film-like exterior member 40, and a wound electrode unit 30 housed in the exterior member 40 with a positive electrode lead 31 and a negative electrode lead 32 attached to the wound electrode unit 30. The battery structure using the film-like exterior member 40 is called a laminate film structure.

For example, the positive electrode lead 31 and the negative electrode lead 32 lead out in the same direction out of the exterior member 40. The positive electrode lead 31 is formed using, for example, metallic material such as aluminum. The negative electrode lead 32 is formed using, for example, metallic material such as copper, nickel, and stainless steel. These metallic materials are formed into, for example, a thin plate or a mesh.

The exterior member 40 is formed using, for example, an aluminum laminate film that includes a nylon film, an aluminum foil, and a polyethylene film laminated in this order. For example, the exterior member 40 is structured from a pair of rectangular aluminum laminate films fused or bonded with an adhesive at the peripheries with the polyethylene films facing the wound electrode unit 30.

An adhesive film 41 that prevents entry of external air is inserted between the exterior member 40 and the positive and negative electrode leads 31 and 32. The adhesive film 41 is configured using a material that has adhesion to the positive electrode lead 31 and the negative electrode lead 32. Examples of such material include polyolefin resins such as polyethylene, polypropylene, modified-polyethylene, and modified-polypropylene.

The exterior member 40 may be configured from laminate films of other laminate structures, instead of the aluminum laminate film, or from a polypropylene or other polymer films, or metal films.

FIG. 7 is a cross section of the wound electrode unit 30 of FIG. 6, taken along the line I-I. The wound electrode unit 30 is a wound unit of a positive electrode 33 and a negative electrode 34 laminated via a separator 35 and an electrolyte 36. The outermost periphery of the wound electrode unit 30 is protected by a protective tape 37.

The positive electrode 33 is structured to include, for example, a positive electrode active material layer 33B on the both sides of a positive electrode collector 33A, and a coating that originates from at least one of the imide salts of formulae (I) and formula (II) is formed on the positive electrode surface.

The negative electrode 34 is structured to include, for example, a negative electrode active material layer 34B on the both sides of a negative electrode collector 34A, and a coating that originates from at least one of the heteropolyacids and heteropolyacid compounds of formulae (III) to (VI) is formed on the negative electrode surface. The heteropolyacid compound coating is a deposit of a three-dimensional mesh structure formed by the electrolysis of the heteropolyacid compound, and exists as a gel coating that contains amorphous polyacid with the nonaqueous electrolytic solution in this structure in the battery system.

The positive electrode 33 and the negative electrode 34 are disposed in such a manner that the negative electrode active material layer 34B and the positive electrode active material layer 33B are on the opposite sides. The positive electrode collector 33A, the positive electrode active material layer 33B, the negative electrode collector 34A, the negative electrode active material layer 34B, and the separator 35 are configured the same way as the positive electrode collector 21A, the positive electrode active material layer 21B, the negative electrode collector 22A, the negative electrode active material layer 22B, and the separator 23 of Second Embodiment.

The electrolyte 36 is a so-called gel electrolyte, including the nonaqueous electrolytic solution of First Embodiment, and a polymer compound that retains the nonaqueous electrolytic solution. The gel electrolyte is preferable, because it provides high ion conductivity (for example, 1 mS/cm or more at room temperature), and prevents leaking.

### (3-2) Producing Method of Nonaqueous Electrolyte Battery

The nonaqueous electrolyte battery is produced using, for example, three producing methods (first to third producing methods), as follows.

### (3-2-1) First Producing Method

In the first producing method, for example, the positive electrode active material layer 33B is first formed on the both sides of the positive electrode collector 33A to form the positive electrode 33, according to the procedure used to form the positive electrode 21 and the negative electrode 22 in Second Embodiment. The negative electrode active material layer 34B is formed on the both sides of the negative electrode collector 34A to form the negative electrode 34.

A separately prepared precursor solution containing the nonaqueous electrolytic solution of First Embodiment, the polymer compound, and the solvent is coated over the positive electrode 33 and the negative electrode 34, and the solvent is evaporated to form the gel electrolyte 36. Then, the positive electrode lead 31 and the negative electrode lead 32 are attached to the positive electrode collector 33A and the negative electrode collector 34A, respectively.

The positive electrode 33 and the negative electrode 34 with the electrolyte 36 are then laminated via the separator 35, and wound along the longitudinal direction. The protective tape 37 is then bonded to the outermost periphery to fabricate the wound electrode unit 30. Finally, the wound electrode unit 30 is placed between, for example, a pair of film-like exterior members 40, and sealed therein by bonding the exterior members 40 at the peripheries by, for example, heatfusion. The adhesive film 41 is inserted between the positive and negative electrode leads 31 and 32 and the exterior members 40. This completes the nonaqueous electrolyte battery.

### (3-2-2) Second Producing Method

In the second producing method, firstly, the positive electrode lead 31 and the negative electrode lead 32 are attached to the positive electrode 33 and the negative electrode 34, respectively. The positive electrode 33 and the negative electrode 34 are then laminated and wound around with the separator 35 in between, and the protective tape 37 is bonded to the outermost periphery to obtain a wound unit as a precursor of the wound electrode unit 30.

The wound unit is then placed between a pair of film-like exterior members 40, which are then bonded by, for example, heatfusion at the peripheries, leaving one side open. As a result, the wound unit is housed inside the bag of the exterior member 40. Then, an electrolyte composition is prepared that includes the nonaqueous electrolytic solution of First Embodiment, the raw material monomer of the polymer compound, a polymerization initiator, and optional materials such as a polymerization inhibitor, and the electrolyte composition is injected into the bag of the exterior member 40. The opening of the exterior member 40 is then sealed by, for example, heatfusion. Finally, the monomer is heat polymerized into the polymer compound, and the gel electrolyte 36 is formed. This completes the nonaqueous electrolyte battery.

### (3-2-3) Third Producing Method

In the third producing method, a wound unit is formed and housed in the bag of the exterior member 40 in the same manner as in the second producing method, except that the polymer compound is coated on the both sides of the separator 35 in advance.

The polymer compound coated on the separator 35 may be, for example, a polymer that includes a vinylidene fluoride component, specifically, a homopolymer, a copolymer, or a multicomponent copolymer. Specific examples include polyvinylidene fluoride, binary copolymers that include vinylidene fluoride and hexafluoropropylene components, and ternary copolymers that include vinylidene fluoride, hexafluoropropylene, and chlorotrifluoroethylene components.

Note that the polymer compound may include one or more other polymer compounds, in addition to the polymer that includes a vinylidene fluoride component. Then, the nonaqueous electrolytic solution of First Embodiment is prepared, and injected into the exterior member 40, and the opening of the exterior member 40 is sealed by, for example, heatfusion. Finally, the exterior member 40 is heated under applied load to contact the separator 35 with the positive electrode 33 and the negative electrode 34 via the polymer compound. As a result, the nonaqueous electrolytic solution impregnates the polymer compound, causing the polymer compound to gel and form the electrolyte 36. This completes the nonaqueous electrolyte battery.

By the preliminary charging or charging of the nonaqueous electrolyte battery fabricated according to the first to third producing methods, the anion of the imide salt of formula (I) or (II) is adsorbed in the electrode surface, and a coating that originates from at least one of the heteropolyacids and heteropolyacid compounds of formulae (III) to (VI) is formed on the negative electrode surface.

### Advantages

The effects obtained in Second Embodiment also can be obtained in Third Embodiment.

### 4. Fourth Embodiment

A nonaqueous electrolyte battery according to Fourth Embodiment of the present disclosure is described below. The nonaqueous electrolyte battery of Fourth Embodiment is a laminate film-type nonaqueous electrolyte battery with the laminate film exterior, and does not differ from the nonaqueous electrolyte battery of Third Embodiment, except that the nonaqueous electrolytic solution of First Embodiment is directly used. Accordingly, the following description primarily deals with differences from Third Embodiment.

### (4-1) Configuration of Nonaqueous Electrolyte Battery

The nonaqueous electrolyte battery according to Fourth Embodiment of the present disclosure uses the nonaqueous electrolytic solution instead of the gel electrolyte 36. Thus, the wound electrode unit 30 does not include the electrolyte 36, and instead includes the nonaqueous electrolytic solution impregnating the separator 35.

### (4-2) Producing Method of Nonaqueous Electrolyte Battery

The nonaqueous electrolyte battery can be produced, for example, as follows.

First, for example, the positive electrode active material, the binder, and the conductive agent are mixed to prepare a positive electrode mixture, which is then dispersed in a solvent such as N-methyl-2-pyrrolidone to obtain a positive electrode mixture slurry. The positive electrode mixture slurry coated on the both sides, dried, and compression molded to form the positive electrode active material layer 33B and obtain the positive electrode 33. Thereafter, for example, the positive electrode lead 31 is attached to the positive electrode collector 33A, for example, by ultrasonic welding or spot welding.

For example, the negative electrode material and the binder are mixed to prepare a negative electrode mixture, which is then dispersed in a solvent such as N-methyl-2-pyrrolidone to obtain a negative electrode mixture slurry. The negative electrode mixture slurry is coated on the both sides of the negative electrode collector 34A, dried, and compression molded to form the negative electrode active material layer 34B and obtain the negative electrode 34. Thereafter, for example, the negative electrode lead 32 is attached to the negative electrode collector 34A, for example, by ultrasonic welding or spot welding.

The positive electrode 33 and the negative electrode 34 are wound around with the separator 35 in between, and installed in the exterior member 40. The nonaqueous electrolytic solution of First Embodiment is then injected into the exterior member 40, and the exterior member 40 is sealed. As a result, the nonaqueous electrolyte battery shown in FIGS. 6 and 7 is obtained.

### Advantages

The effects obtained in Second Embodiment also can be obtained in Fourth Embodiment.

### 5. Fifth Embodiment

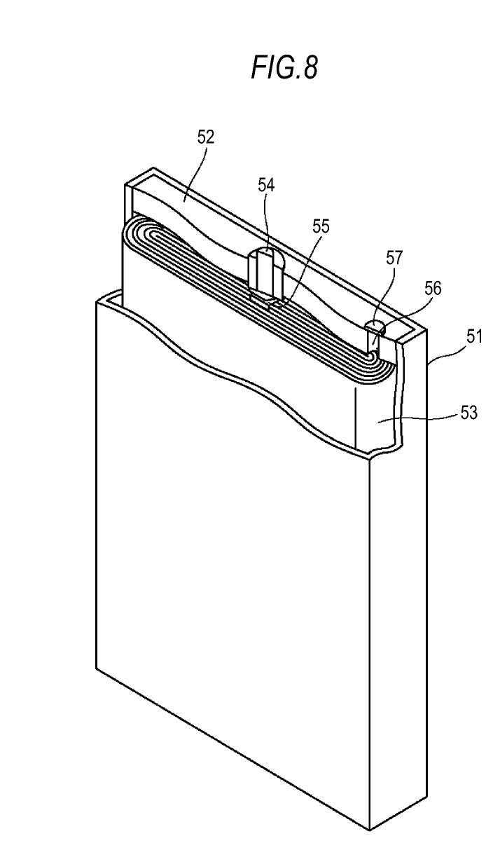

An exemplary configuration of a nonaqueous electrolyte battery 20 according to Fifth Embodiment of the present disclosure is described below. The nonaqueous electrolyte battery 20 according to Fifth Embodiment of the present disclosure has a rectangular shape, as illustrated in FIG. 8.

The nonaqueous electrolyte battery 20 is fabricated as follows. As illustrated in FIG. 8, first, a wound electrode unit 53 is housed in an exterior canister 51, a metallic rectangular canister made from metal, for example, such as aluminum (Al), and iron (Fe).

An electrode pin 54 provided on a battery lid 52 is then connected to an electrode terminal 55 leading out from the wound electrode unit 53, and a seal is made with the battery lid 52. Then, a nonaqueous electrolytic solution containing the imide salt of formula (I) or (II) and at least one of the heteropolyacids and heteropolyacid compounds of formulae (III) to (VI) is injected into the nonaqueous electrolytic solution through a nonaqueous electrolytic solution inlet 56, which is then sealed with a sealing member 57. In response to the charging or preliminary charging of the battery so fabricated, the anions of the imide salt of formula (I) or (II) are adsorbed on the electrode surfaces, and a compound that originates from at least one of the heteropolyacids and heteropolyacid compounds of formulae (III) to (VI) deposits on the surface of the negative electrode 14. This completes the nonaqueous electrolyte battery 20 of Fifth Embodiment of the present disclosure.

Note that the wound electrode unit 53 is obtained by laminating the positive electrode and the negative electrode via the separator, and winding the electrodes. The positive electrode, the negative electrode, the separator, and the nonaqueous electrolytic solution are as described in First Embodiment, and will not be described further.

### Advantages

The nonaqueous electrolyte battery 20 of Fifth Embodiment of the present disclosure can suppress decreases in percentage remaining capacity, and gas production under high-temperature environment, and decreases in percentage remaining capacity during continued use. Thus, damages caused by increased inner pressure due to gas production, and lowering in battery characteristics can be prevented.

### 6. Sixth Embodiment

A nonaqueous electrolyte battery according to Sixth Embodiment of the present disclosure is described below. The nonaqueous electrolyte battery according to Sixth Embodiment is a laminate film-type nonaqueous electrolyte battery in which the electrode unit as a laminate of the positive electrode and the negative electrode is sheathed with a laminate film. Sixth Embodiment does not differ from Third Embodiment except for the configuration of the electrode unit. Accordingly, the following description only deals with the electrode unit of Sixth Embodiment.

### Positive Electrode and Negative Electrode

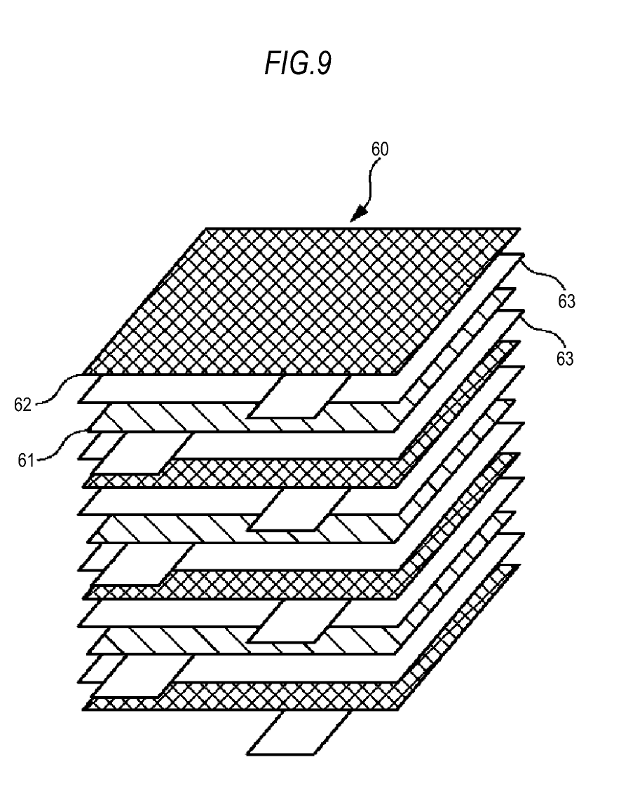

As illustrated in FIG. 9, a positive electrode 61 is obtained by forming a positive electrode active material layer on the both sides of a rectangular positive electrode collector. Preferably, the positive electrode collector of the positive electrode 61 is formed integrally with the positive electrode terminal. Similarly, a negative electrode 62 is obtained by forming a negative electrode active material layer on a rectangular negative electrode collector.

The positive electrode 61 and the negative electrode 62 are laminated in turn with a separator 63 in between, and an electrode laminate 60 is formed. The laminated state of the electrodes in the electrode laminate 60 may be maintained by attaching an insulating tape or the like. The electrode laminate 60 is sheathed with, for example, a laminate film, and sealed inside a battery with the nonaqueous electrolytic solution. The gel electrolyte may be used instead of the nonaqueous electrolytic solution.

### EXAMPLES

Specific examples of the present disclosure are described below. It should be noted, however, that the present disclosure is not restricted by the following descriptions.

The following imide salts were used in Examples and Comparative Examples.

Compound A: Lithium bis(fluorosulfonyl)imide
Compound B: Lithium bis(trifluoromethanesulfonyl)imide
Compound C: Lithium bis(pentafluoroethanesulfonyl)imide
Compound D: Lithium bis(nonafluorobutanesulfonyl)imide
Compound E: Perfluoropropane-1,3-disulfonylimide lithium phosphotungstate

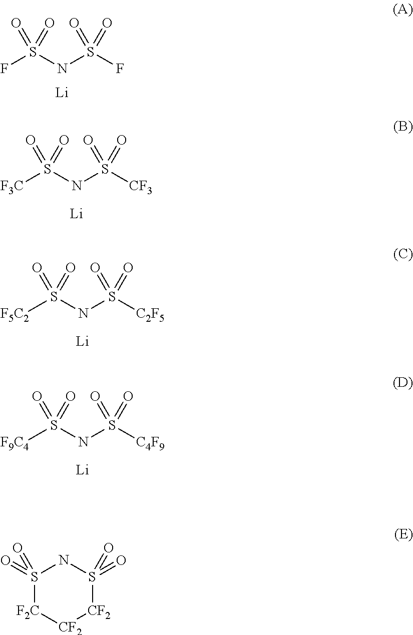

The following heteropolyacids were used in Examples and Comparative Examples. Note that the heteropolyacids below all include polyacid ions of the Keggin structure.

Compound F: Silicomolybdic acid heptahydrate
Compound G: Silicotungstic acid heptahydrate
Compound H: Phosphomolybdic acid heptahydrate
Compound I: Phosphotungstic acid heptahydrate

Note that the mass of the heteropolyacid is the mass excluding the mass of the heteropolyacid bonding water. Similarly, the mass of the heteropolyacid compound is the mass excluding the mass of the heteropolyacid compound bonding water.

### Example 1

In Example 1, the characteristics of laminate film-type batteries were evaluated with varying amounts of imide salt and heteropolyacid added to the electrolytic solution.

### Example 1-1

### Fabrication of Positive Electrode

94 parts by mass of the positive electrode active material lithium cobalt oxide (LiCoO₂), 3 parts by mass of the conductive agent graphite, and 3 parts by mass of the binder polyvinylidene fluoride (PVdF) were mixed, and N-methylpyrrolidone was added to obtain a positive electrode mixture slurry. The positive electrode mixture slurry was then evenly coated over the both surfaces of a 10-μm thick aluminum foil, dried, and compression molded with a roller press machine to obtain a positive electrode sheet provided with a positive electrode active material layer (volume density of 3.40 g/cc). Finally, the positive electrode sheet was cut into a 50-mm width and a 300-mm length, and an aluminum (Al) positive electrode lead was welded to one end of the positive electrode collector to obtain a positive electrode.

### Fabrication of Negative Electrode

97 parts by mass of the negative electrode active material mesocarbon microbeads (MCMB), and 3 parts by mass of the binder polyvinylidene fluoride (PVdF) were mixed, and N-methylpyrrolidone was added to obtain a negative electrode mixture slurry. The negative electrode mixture slurry was then evenly coated over the both surfaces of a 10-μm thick copper foil (negative electrode collector), dried, and compression molded with a roller press machine to obtain a negative electrode sheet provided with a negative electrode active material layer (volume density of 1.80 g/cc). Finally, the negative electrode sheet was cut into a 50-mm width and a 300-mm length, and a nickel (Ni) negative electrode lead was welded to one end of the negative electrode collector to obtain a negative electrode.

### Adjustment of Nonaqueous Electrolytic Solution

0.99 mol/kg of the electrolyte salt lithium hexafluorophosphate (LiPF₆), and 0.01 mol/kg of lithium bis(fluorosulfonyl)imide (imide salt, compound A) were added to a 3:7 (mass ratio) mixture of ethylene carbonate (EC) and diethyl carbonate (DEC) in a total of 1.0 mol/kg. Then, 0.5 weight % of silicomolybdic acid heptahydrate (heteropolyacid, compound F) was dissolved therein.

### Battery Assembly

The positive electrode and the negative electrode were laminated via a separator provided in the form of a 7 μm-thick microporous polypropylene film. The laminate was wound multiple times along the longitudinal direction of the laminate, and the terminating end was fixed with an adhesive tape to obtain a flat wound electrode unit. The wound electrode unit was then placed in a bag-like exterior member of an aluminum laminate film. After injecting 2 g of an electrolytic solution, the bag was heat fused under reduced pressure to seal the opening of the aluminum laminate film. The laminate film-type battery of Example 1-1 was fabricated in this manner.

Formation of a gel coating on the negative electrode surface was confirmed in the battery disassembled after preliminary charging.

### Example 1-2

A laminate film-type battery was fabricated in the same manner as in Example 1-1, except that 0.025 mol/kg of the imide salt compound A was added to make the total amount 1.0 mol/kg with the electrolyte salt.

### Example 1-3

A laminate film-type battery was fabricated in the same manner as in Example 1-1, except that 0.05 mol/kg of the imide salt compound A was added to make the total amount 1.0 mol/kg with the electrolyte salt.

### Example 1-4

A laminate film-type battery was fabricated in the same manner as in Example 1-1, except that the heteropolyacid compound F was mixed in an amount of 0.01 weight %.

### Example 1-5

A laminate film-type battery was fabricated in the same manner as in Example 1-1, except that the heteropolyacid compound F was mixed in an amount of 0.05 weight %.

### Example 1-6

A laminate film-type battery was fabricated in the same manner as in Example 1-1, except that the heteropolyacid compound F was mixed in an amount of 0.1 weight %.

### Example 1-7

A laminate film-type battery was fabricated in the same manner as in Example 1-1, except that the heteropolyacid compound F was mixed in an amount of 0.5 weight %.

### Example 1-8

A laminate film-type battery was fabricated in the same manner as in Example 1-1, except that the heteropolyacid compound F was mixed in an amount of 1.0 weight %.

### Example 1-9

A laminate film-type battery was fabricated in the same manner as in Example 1-1, except that the heteropolyacid compound F was mixed in an amount of 2.0 weight %.

### Example 1-10

A laminate film-type battery was fabricated in the same manner as in Example 1-1, except that 0.2 mol/kg of the imide salt compound A was added to make the total amount 1.0 mol/kg with the electrolyte salt.

### Example 1-11

A laminate film-type battery was fabricated in the same manner as in Example 1-1, except that 0.3 mol/kg of the imide salt compound A was added to make the total amount 1.0 mol/kg with the electrolyte salt.

### Examples 1-12 to 1-22

Laminate film-type batteries were fabricated in the same manner as in Examples 1-1 to 1-11, except for the composition of the electrolytic solution, which contained 1.0 weight % of vinylene carbonate (VC) added as the nonaqueous solvent.

### Comparative Example 1-1

A laminate film-type battery was fabricated in the same manner as in Example 1-1, except that 1.0 weight % of vinylene carbonate (VC) was added as the nonaqueous solvent, and that the imide salt compound A and the heteropolyacid compound F were not added.

### Comparative Example 1-2

A laminate film-type battery was fabricated in the same manner as in Example 1-1, except that 1.0 weight % of vinylene carbonate (VC) was added as the nonaqueous solvent, and that the imide salt compound A was added in a concentration of 0.1 mol/kg, without adding the heteropolyacid compound F.

### Comparative Example 1-3

A laminate film-type battery was fabricated in the same manner as in Example 1-1, except that 1.0 weight % of vinylene carbonate (VC) was added as the nonaqueous solvent, and that the imide salt compound A was added in a concentration of 0.2 mol/kg, without adding the heteropolyacid compound F.

### Comparative Example 1-4

A laminate film-type battery was fabricated in the same manner as in Example 1-1, except that 1.0 weight % of vinylene carbonate (VC) was added as the nonaqueous solvent, and that the imide salt compound A was not mixed.

### Comparative Example 1-5

A laminate film-type battery was fabricated in the same manner as in Example 1-1, except that 1.0 weight % of vinylene carbonate (VC) was added as the nonaqueous solvent, and that 1.0 weight % of the heteropolyacid compound F was mixed, without mixing the imide salt compound A.

### Comparative Example 1-6

A laminate film-type battery was fabricated in the same manner as in Example 1-1, except that 5.0 weight % of vinylene carbonate (VC) was added as the nonaqueous solvent, and that the imide salt compound A and the heteropolyacid compound F were not added.

### Comparative Example 1-7

A laminate film-type battery was fabricated in the same manner as in Example 1-1, except that 5.0 weight % of vinylene carbonate (VC) was added as the nonaqueous solvent, and that the imide salt compound A was added in a concentration of 0.1 mol/kg, without adding the heteropolyacid compound F.

### Comparative Example 1-8

A laminate film-type battery was fabricated in the same manner as in Example 1-1, except that 5.0 weight % of vinylene carbonate (VC) was added as the nonaqueous solvent, and that the imide salt compound A was added in a concentration of 0.2 mol/kg, without adding the heteropolyacid compound F.

### Comparative Example 1-9

A laminate film-type battery was fabricated in the same manner as in Example 1-1, except that 1.0 weight % of fluoroethylene carbonate (FEC) was added as the nonaqueous solvent, and that the imide salt compound A and the heteropolyacid compound F were not added.

### Comparative Example 1-10

A laminate film-type battery was fabricated in the same manner as in Example 1-1, except that 1.0 weight % of fluoroethylene carbonate (FEC) was added as the nonaqueous solvent, and that the imide salt compound A was added in a concentration of 0.1 mol/kg, without adding the heteropolyacid compound F.

### Comparative Example 1-11

A laminate film-type battery was fabricated in the same manner as in Example 1-1, except that 1.0 weight % of fluoroethylene carbonate (FEC) was added as the nonaqueous solvent, and that the imide salt compound A was added in a concentration of 0.2 mol/kg, without adding the heteropolyacid compound F.

### Comparative Example 1-12

A laminate film-type battery was fabricated in the same manner as in Example 1-1, except that 5.0 weight % of fluoroethylene carbonate (FEC) was added as the nonaqueous solvent, and that the imide salt compound A and the heteropolyacid compound F were not added.

### Comparative Example 1-13

A laminate film-type battery was fabricated in the same manner as in Example 1-1, except that 5.0 weight % of fluoroethylene carbonate (FEC) was added as the nonaqueous solvent, and that the imide salt compound A was added in a concentration of 0.1 mol/kg, without adding the heteropolyacid compound F.

### Comparative Example 1-14

A laminate film-type battery was fabricated in the same manner as in Example 1-1, except that 5.0 weight % of fluoroethylene carbonate (FEC) was added as the nonaqueous solvent, and that the imide salt compound A was added in a concentration of 0.2 mol/kg, without adding the heteropolyacid compound F.

The batteries of Examples and Comparative Examples were evaluated as follows.

### Battery Evaluation

(a) Extent of Battery Swelling after Initial Charging

After measuring the initial battery thickness of each battery of Examples and Comparative Examples, the battery was charged to a voltage of 4.2 V under 800-mA constant current in a 23° C. environment, and charged further for a total charge time of 3 hours under the constant voltage of 4.2 V. The battery thickness after the initial charging was then measured. To find the extent of battery swelling, changes in battery thickness after the initial charging was calculated according to the following equation.

Changes in battery thickness after initial charging [%]=(battery thickness after initial charging/initial battery thickness)×100

### (b) High-Temperature Cycle Test

Each battery was charged to the upper limit voltage 4.2 V under a constant current of 0.5 C in a 23° C. atmosphere, and charged further to the charge current of 0.05 C under the constant voltage of 4.2 V. The battery was then discharged to the final voltage of 3.0 V at 0.5 C. This charge and discharge cycle was repeated twice, and the discharge capacity after the second cycle was measured.

Then, the charge and discharge cycle was repeated in 300 cycles under the foregoing conditions in a 50° C. atmosphere, and the discharge capacity after the 300 cycles was measured. The percentage remaining discharge capacity after the 300 cycles relative to the discharge capacity after the second cycle was calculated according to the following equation.

Percentage remaining discharge capacity [%]=(discharge capacity after 300 cycles/discharge capacity after 2 cycles)×100

Note that “0.5 C” is the current value with which the theoretical capacity fully discharges in 2 hours.

### (c) High-Temperature Continuous Charging Test

The thickness of each battery before charging was measured. The battery was charged to the upper limit voltage of 4.25 V under a constant current of 0.5 C in a 50° C. atmosphere, and charged further to the current value of 0.05 C at the constant voltage of 4.25 V. Charging was continued for 300 hours in the same atmosphere to the final current of 0 mA, and the battery thickness after the continuous charging was measured.

An increase in battery thickness after the high-temperature continuous charging was calculated according to the following equation.

Battery thickness increase [%]=(battery thickness increase after continuous charging/battery thickness before charging)×100

(d) Percentage Remaining Discharge Capacity after High-Temperature Continuous Charging

The percentage remaining discharge capacity after the constant current discharge of the continuously charged battery to the final voltage of 3.0 V at 0.5 C was determined as in the (c) high-temperature continuous charging test. The percentage remaining discharge capacity after the high-temperature continuous charging was calculated according to the following equation.

Percentage remaining discharge capacity after high-temperature continuous charging [%]=(discharge capacity after high-temperature continuous charging/discharge capacity after 2 cycles)×100

### (e) Changes in Amount of Detected Metal Atoms on Electrode Surface

Batteries in the discharge state after the initial charge and discharge and after the high-temperature continuous charging were disassembled. The negative electrode surface of each disassembled battery was then observed with SEM-EDX, and the amount of metal atoms originating from the heteropolyacid on the negative electrode surface was measured. Changes in the amount of metal atoms in the batteries after the high-temperature continuous charging were then calculated.

The “metal atoms” measured in Example 1 are the molybdenum atoms in the silicomolybdic acid heptahydrate (heteropolyacid, compound F) added to the electrolytic solution. Smaller changes mean less dissolving and thus more stability in the SEI coating initially formed on the negative electrode surface, and thus indicate less deterioration during high-temperature use.

Note that the measurement was made only in Examples 1-1 to 1-22 and Comparative Examples 1-4 and 1-5 in which the heteropolyacid was added.

Tables 1 and 2 below present the test results.

TABLE 1

| | Cyclic carbonate | | Imide salt compound | | Heteropolyacid compound | |
|---|---|---|---|---|---|---|
| | | Amount added | | Concentration | | Amount added |
| | Type | [weight %] | Type | [mol/kg] | Type | [weight %] |
| Example 1-1 | — | — | Compound A | 0.01 | Compound F | 0.5 |
| Example 1-2 | | | | 0.025 | | |
| Example 1-3 | | | | 0.05 | | |
| Example 1-4 | | | | 0.1 | | 0.01 |
| Example 1-5 | | | | | | 0.05 |
| Example 1-6 | | | | | | 0.1 |
| Example 1-7 | | | | | | 0.5 |
| Example 1-8 | | | | | | 1.0 |
| Example 1-9 | | | | | | 2.0 |
| Example 1-10 | | | | 0.2 | | 0.5 |
| Example 1-11 | | | | 0.3 | | |
| Example 1-12 | VC | 1.0 | Compound A | 0.01 | Compound F | 0.5 |
| Example 1-13 | | | | 0.025 | | |
| Example 1-14 | | | | 0.05 | | |
| Example 1-15 | | | | 0.1 | | 0.01 |
| Example 1-16 | | | | | | 0.05 |
| Example 1-17 | | | | | | 0.1 |
| Example 1-18 | | | | | | 0.5 |
| Example 1-19 | | | | | | 1.0 |
| Example 1-20 | | | | | | 2.0 |
| Example 1-21 | | | | 0.2 | | 0.5 |
| Example 1-22 | | | | 0.3 | | |

| | | Percentage increase in | | |
|---|---|---|---|---|
| | | battery thickness after | Percentage remaining | |
| | Percentage remaining | high-temperature | discharge capacity after | Changes in detected |
| | discharge capacity at high | continuous charging | continuous charging | amount of metal atoms |
| | temperature [%] | [%] | [%] | [Number of atoms, %] |
| Example 1-1 | 74 | 22.3 | 78 | 0.44 |
| Example 1-2 | 82 | 12.3 | 80 | 0.31 |
| Example 1-3 | 83 | 9.5 | 82 | 0.16 |
| Example 1-4 | 79 | 30.6 | 79 | <0.1 |
| Example 1-5 | 81 | 14.1 | 80 | <0.1 |
| Example 1-6 | 82 | 9.9 | 84 | <0.1 |
| Example 1-7 | 84 | 9.3 | 85 | 0.18 |
| Example 1-8 | 84 | 9.0 | 80 | 0.27 |
| Example 1-9 | 82 | 8.7 | 76 | 0.28 |
| Example 1-10 | 80 | 9.0 | 82 | 0.18 |
| Example 1-11 | 78 | 9.8 | 81 | 0.15 |
| Example 1-12 | 76 | 24.6 | 79 | 0.45 |
| Example 1-13 | 83 | 12.6 | 81 | 0.33 |
| Example 1-14 | 85 | 9.8 | 84 | 0.18 |
| Example 1-15 | 80 | 32.7 | 80 | <0.1 |
| Example 1-16 | 82 | 15.4 | 82 | <0.1 |
| Example 1-17 | 85 | 10.9 | 86 | <0.1 |
| Example 1-18 | 86 | 9.5 | 88 | 0.17 |
| Example 1-19 | 86 | 9.1 | 82 | 0.29 |
| Example 1-20 | 84 | 9.0 | 78 | 0.28 |
| Example 1-21 | 81 | 9.2 | 83 | 0.18 |
| Example 1-22 | 78 | 10.1 | 83 | 0.16 |

TABLE 2

| | Cyclic carbonate | | Imide salt compound | | Heteropolyacid compound | |
|---|---|---|---|---|---|---|
| | | Amount added | | Concentration | | Amount added |
| | Type | [weight %] | Type | [mol/kg] | Type | [weight %] |
| Comparative Example 1-1 | VC | 1.0 | — | — | — | — |
| Comparative Example 1-2 | | | Compound A | 0.1 | — | — |
| Comparative Example 1-3 | | | | 0.2 | — | — |
| Comparative Example 1-4 | | | — | — | Compound F | 0.5 |
| Comparative Example 1-5 | | | — | — | | 1 |
| Comparative Example 1-6 | VC | 5.0 | — | — | — | — |
| Comparative Example 1-7 | | | Compound A | 0.1 | | |
| Comparative Example 1-8 | | | | 0.2 | | |
| Comparative Example 1-9 | FEC | 1.0 | — | — | — | — |
| Comparative Example 1-10 | | | Compound A | 0.1 | | |
| Comparative Example 1-11 | | | | 0.2 | | |
| Comparative Example 1-12 | FEC | 5.0 | — | — | — | — |
| Comparative Example 1-13 | | | Compound A | 0.1 | | |
| Comparative Example 1-14 | | | | 0.2 | | |

| | | Percentage increase in | | |
|---|---|---|---|---|
| | | battery thickness | | |
| | | after | Percentage remaining | |
| | Percentage remaining | high-temperature | discharge capacity | Changes in detected |
| | discharge capacity at | continuous charging | after continuous | amount of metal atoms |
| | high temperature [%] | [%] | charging [%] | [Number of atoms, %] |
| Comparative Example 1-1 | 67 | 54.2 | 71 | — |
| Comparative Example 1-2 | 74 | 36.5 | 78 | — |
| Comparative Example 1-3 | 72 | 36.8 | 75 | — |
| Comparative Example 1-4 | 68 | 27.3 | 75 | 2.01 |
| Comparative Example 1-5 | 70 | 21.3 | 77 | 3.86 |
| Comparative Example 1-6 | 70 | 55.3 | 68 | — |
| Comparative Example 1-7 | 75 | 41.9 | 76 | — |
| Comparative Example 1-8 | 72 | 42.2 | 72 | — |
| Comparative Example 1-9 | 70 | 55.0 | 70 | — |
| Comparative Example 1-10 | 73 | 36.6 | 77 | — |
| Comparative Example 1-11 | 73 | 36.8 | 75 | — |
| Comparative Example 1-12 | 72 | 62.4 | 70 | — |
| Comparative Example 1-13 | 75 | 48.1 | 75 | — |
| Comparative Example 1-14 | 74 | 48.4 | 72 | — |

As can be seen from the results presented in Tables 1 and 2, the battery characteristics under high-temperature environment improve with the nonaqueous electrolyte that contains the imide salt and the heteropolyacid according to the present disclosure.

For example, there are notable improvements in percentage remaining capacity in Examples 1-15 to 1-20 in which the imide salt and the heteropolyacid were added, compared to Comparative Example 1-1 in which the imide salt and the heteropolyacid were not added. It can also be seen that changes in battery thickness are smaller.

Further, by comparing Examples 1-15 to 1-20 and Comparative Example 1-2, it can be seen that the battery characteristics improve in Examples 1-15 to 1-20 in which both the imide salt (0.1 mol/kg) and the heteropolyacid were added.

The addition of imide salt improves the battery characteristics to some extent, as can be seen from the comparison of Comparative Example 1-1 (no addition of the imide salt and the heteropolyacid) and Comparative Examples 1-2 and 1-3 (addition of only the imide salt). The improvement is considered to be due to the imide salt suppressing the deterioration of the positive electrode. The use of the nonaqueous electrolyte containing only the imide salt was found to improve the resistance to continuous charging. However, such nonaqueous electrolytes were insufficient in terms of suppressing a battery thickness increase caused by gas production.

It was also found from Comparative Examples 1-4 and 1-5 that the addition of only the heteropolyacid could not improve the deterioration of discharge capacity at high temperature. This is considered to be due to the insufficient high-temperature stability of the heteropolyacid SEI coating formed at the initial charging, incapable of exhibiting effects as a result of being dissolved in the absence of the imide salt. Thus, a cell thickness increase and discharge capacity after high-temperature continuous charging can be improved with the use of the nonaqueous electrolyte that contains the imide salt and the heteropolyacid according to the present disclosure.

By comparing Comparative Examples and Examples, the addition of both the imide salt and the heteropolyacid was found to notably improve battery characteristics, including high percentage remaining discharge capacity and small battery thickness changes, regardless of the amounts added.

Unless the imide salt and the heteropolyacid were added, battery characteristics did not improve with the fluoroethylene carbonate (FEC) used as the cyclic carbonate. Increasing the amounts of the reactive cyclic carbonate vinylene carbonate (VC) and fluoroethylene carbonate (FEC) in the presence of the imide salt did not improve battery characteristics during high-temperature use, but made the battery characteristics worse. It is known that cyclic carbonates decompose and form a negative electrode coating, which suppresses the reaction with the electrolytic solution. However, it was found that the organic negative electrode coating obtained from the mixture of the cyclic carbonate with the imide salt could not sufficiently suppress the decomposition reaction of the imide salt at the negative electrode, and that the foregoing effect was largely provided by the inorganic coating originating from the heteropolyacid.

It was found from Examples that the co-presence of at least 0.01 mol/kg of imide salt and at least 0.01 weight % of heteropolyacid was very effective at effectively suppressing the side reactions at the positive and negative electrodes during the continuous charge, and at improving the high-temperature characteristics. It was also found that the presence of the heteropolyacid suppresses the lowering of discharge capacity associated with increased imide salt amounts.

The co-presence of the imide salt and the heteropolyacid was also found to be highly effective, even without the cyclic carbonate used as the nonaqueous solvent. The effects improved even further with the use of the nonaqueous electrolyte that contained the cyclic carbonate.

### Example 2

In Example 2, the characteristics of laminate film-type batteries were evaluated with different combinations of the imide salt compounds A to E and the heteropolyacid compounds F to I.

### Example 2-1

A laminate film-type battery was fabricated in the same manner as in Example 1-1, except that 1.0 weight of vinylene carbonate (VC) was mixed in the nonaqueous solvent, and that 0.01 mol/kg of lithium bis(fluorosulfonyl)imide (imide salt, compound A), and 0.5 weight % of silicomolybdic acid heptahydrate (heteropolyacid, compound F) were used.

### Examples 2-2 to 2-4

Laminate film-type batteries were fabricated in the same manner as in Example 2-1, except that silicotungstic acid heptahydrate (compound G), phosphomolybdic acid heptahydrate (compound H), and phosphotungstic acid heptahydrate (compound I) were used as the heteropolyacids.

### Examples 2-5 to 2-8

Laminate film-type batteries were fabricated in the same manner as in Examples 2-1 to 2-4, except that the imide salt lithium bis(trifluoromethanesulfonyl)imide (compound B) was used.

### Examples 2-9 to 2-12

Laminate film-type batteries were fabricated in the same manner as in Examples 2-1 to 2-4, except that the imide salt lithium bis(pentafluoroethanesulfonyl)imide (compound C) was used.

### Examples 2-13 to 2-16

Laminate film-type batteries were fabricated in the same manner as in Examples 2-1 to 2-4, except that the imide salt lithium bis(nonafluorobutanesulfonyl)imide (compound D) was used.

### Examples 2-17 to 2-20

Laminate film-type batteries were fabricated in the same manner as in Examples 2-1 to 2-4, except that the imide salt perfluoropropane-1,3-disulfonylimide lithium phosphotungstate (compound E) was used.

### Battery Evaluation

### (a) High-Temperature Cycle Test

### (b) High-Temperature Continuous Charging Test

(c) Percentage Remaining Discharge Capacity after High-Temperature Continuous Charging

The batteries were evaluated with regard to these criteria according to the methods described in Example 1.

Table 3 below presents the test results.

TABLE 3

| | Cyclic carbonate | | Imide salt compound | | Heteropolyacid compound | |
|---|---|---|---|---|---|---|
| | | Amount added | | Concentration | | Amount added |
| | Type | [weight %] | Type | [mol/kg] | Type | [weight %] |
| Example 2-1 | VC | 1.0 | Compound A | 0.1 | Compound F | 0.5 |
| Example 2-2 | | | | | Compound G | |
| Example 2-3 | | | | | Compound H | |
| Example 2-4 | | | | | Compound I | |
| Example 2-5 | | | Compound B | 0.1 | Compound F | |
| Example 2-6 | | | | | Compound G | |
| Example 2-7 | | | | | Compound H | |
| Example 2-8 | | | | | Compound I | |
| Example 2-9 | | | Compound C | 0.1 | Compound F | |
| Example 2-10 | | | | | Compound G | |
| Example 2-11 | | | | | Compound H | |
| Example 2-12 | | | | | Compound I | |
| Example 2-13 | VC | 1.0 | Compound D | 0.1 | Compound F | 0.5 |
| Example 2-14 | | | | | Compound G | |
| Example 2-15 | | | | | Compound H | |
| Example 2-16 | | | | | Compound I | |
| Example 2-17 | | | Compound E | 0.1 | Compound F | |
| Example 2-18 | | | | | Compound G | |
| Example 2-19 | | | | | Compound H | |
| Example 2-20 | | | | | Compound I | |

| | | Percentage increase in battery | Percentage remaining discharge |
|---|---|---|---|
| | Percentage remaining discharge | thickness after high-temperature | capacity after continuous |
| | capacity at high temperature [%]. | continuous charging [%] | charging [%] |
| Example 2-1 | 86 | 9.5 | 88 |
| Example 2-2 | 90 | 8.7 | 88 |
| Example 2-3 | 85 | 10.2 | 85 |
| Example 2-4 | 87 | 9.8 | 86 |
| Example 2-5 | 84 | 9.2 | 87 |
| Example 2-6 | 84 | 9.3 | 88 |
| Example 2-7 | 83 | 9.8 | 84 |
| Example 2-8 | 83 | 9.9 | 86 |
| Example 2-9 | 87 | 9.1 | 85 |
| Example 2-10 | 89 | 9.0 | 86 |
| Example 2-11 | 87 | 9.3 | 85 |
| Example 2-12 | 88 | 9.4 | 83 |
| Example 2-13 | 88 | 8.5 | 83 |
| Example 2-14 | 88 | 8.4 | 83 |
| Example 2-15 | 87 | 8.6 | 82 |
| Example 2-16 | 85 | 8.9 | 82 |
| Example 2-17 | 87 | 9.4 | 87 |
| Example 2-18 | 89 | 9.5 | 89 |
| Example 2-19 | 83 | 9.7 | 85 |
| Example 2-20 | 87 | 10.0 | 86 |

As demonstrated by the results presented in Table 3, the high-temperature cycle and continuous charging characteristics involving reaction at the positive and negative electrodes were found to improve with the use of the imide salt and the heteropolyacid according to the present disclosure. Silicomolybdic acid or silicotungstic acid is particularly preferable as the heteropolyacid from the standpoint of high-temperature cycle and discharge capacity after continuous charging. Compared to the phosphorus counterparts, the silicon-containing heteropolyacids are believed to produce more stable SEI and thus provide higher protection for the electrodes.

### 7. Other Embodiments

While the present disclosure has been described with respect to certain embodiments and examples, the present disclosure is not limited by these embodiments and examples, and various modifications and applications are possible within the scope of the present disclosure.

For example, while the foregoing Embodiments and Examples described batteries of a laminate film type, batteries of a cylindrical battery structure and a rectangular battery structure, the present disclosure is not limited to these. For example, the present disclosure is also applicable to and equally effective in other battery structures, including batteries of coin and button structures, and batteries of a laminated electrode structure. Further, the structure of the wound electrode unit is not limited to the wound structure, and various other structures, for example, such as a laminate structure and a folded structure, also can be used.

The present disclosure contains subject matter related to that disclosed in Japanese Priority Patent Application JP 2010-139690 filed in the Japan Patent Office on Jun. 18, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A nonaqueous electrolyte comprising:
a nonaqueous solvent;
an electrolyte salt;
an imide salt; and
at least one of a heteropolyacid and a heteropolyacid compound.

2. The nonaqueous electrolyte of claim 1, wherein the imide salt comprises at least one of the compounds of the following formulae (I) and (II),
(CₘF₂ₘ₊₁SO₂)(CₙF₂ₙ₊₁SO₂)NLi (I),
where m and n are integers of 0 or more, 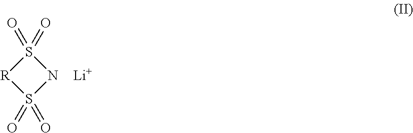
where R represents a linear or branched perfluoroalkylene group of 2 to 4 carbon atoms.

3. The nonaqueous electrolyte of claim 2, wherein the content of the imide salt ranges from 0.01 mol/kg to 1.0 mol/kg, inclusive.

4. The nonaqueous electrolyte of claim 1, wherein the heteropolyacid and the heteropolyacid compound are represented by any of the following formulae (III), (IV), (V), and (VI),
HxAy[BD₆O₂₄].zH₂O Formula (III)
wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦8, 0≦y≦8, and 0≦z≦50, respectively, where at least one of x and y is not 0;
HxAy[BD₁₂O₄₀].zH₂O Formula (IV)
wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦4, 0≦y≦4, and 0≦z≦50, respectively, where at least one of x and y is not 0;
HxAy[B₂D₁₈O₆₂].zH₂O Formula (V)
wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦8, 0≦y≦8, and 0≦z≦50, respectively, where at least one of x and y is not 0;
HxAy[B₅D₃₀O₁₁₀].zH₂O Formula (VI)
wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦15, 0≦y≦15, and 0≦z≦50, respectively, where at least one of x and y is not 0.

5. The nonaqueous electrolyte of claim 4, wherein the total content of the heteropolyacid and the heteropolyacid compound ranges from 0.01 weight % to 3.0 weight %, inclusive.

6. The nonaqueous electrolyte of claim 1, wherein the nonaqueous solvent contains at least one of the cyclic carbonate esters of formulae (VII) to (VIII), 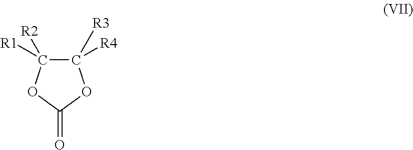
wherein R1 to R4 are hydrogen groups, halogen groups, alkyl groups, or halogenated alkyl groups, and at least one of R1 to R4 is a halogen group or a halogenated alkyl group, 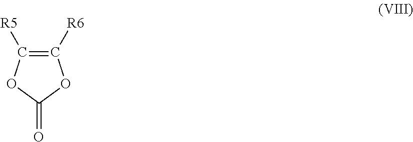
wherein R5 and R6 are hydrogen groups or alkyl groups.

7. The nonaqueous electrolyte of claim 1, wherein the electrolyte salt includes at least one of lithium hexafluorophosphate (LiPF₆), lithium tetrafluoroborate (LiBF₄), lithium perchloride (LiClO₄), and lithium hexafluoroarsenate (LiAsF₆).

8. A nonaqueous electrolyte battery comprising:
a positive electrode;
a negative electrode; and
a nonaqueous electrolyte,
wherein the positive electrode includes a coating that originates from imide salt and is formed in at least a portion on a surface of the positive electrode, and
wherein the negative electrode includes a gel coating formed in at least a portion on a surface of the negative electrode, the gel coating originating from at least one of a heteropolyacid and a heteropolyacid compound, and including an amorphous polyacid and/or polyacid salt compound that contain one or more polyelements.

9. The nonaqueous electrolyte battery of claim 8, wherein the imide salt comprises at least one of the compounds of the following formulae (I) and (II),
(CₘF₂ₘ₊₁SO₂)(CₙF₂ₙ₊₁SO₂)NLi (I),
where m and n are integers of 0 or more, 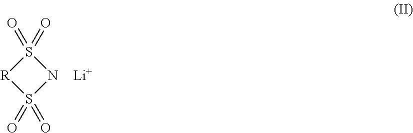
where R represents a linear or branched perfluoroalkylene group of 2 to 4 carbon atoms.

10. The nonaqueous electrolyte battery of claim 9, wherein the heteropolyacid and the heteropolyacid compound are represented by any of the following formulae (III), (IV), (V), and (VI),
HxAy[BD₆O₂₄].zH₂O Formula (III)
wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦8, 0≦y≦8, and 0≦z≦50, respectively, where at least one of x and y is not 0;
HxAy[BD₁₂O₄₀].zH₂O Formula (IV)
wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦4, 0≦y≦4, and 0≦z≦50, respectively, where at least one of x and y is not 0;
HxAy[B₂S₁₈O₆₂].zH₂O Formula (V)
wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦8, 0≦y≦8, and 0≦z≦50, respectively, where at least one of x and y is not 0;
HxAy[B₅D₃₀O₁₁₀].zH₂O Formula (VI)
wherein A represents lithium (Li), sodium (Na), potassium (K), rubidium (Rb), cesium (Cs), magnesium (Mg), calcium (Ca), aluminum (Al), ammonium (NH₄), an ammonium salt, or a phosphonium salt, B represents phosphorus (P), silicon (Si), arsenic (As), or germanium (Ge), D is one or more elements selected from titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re), and thallium (Tl), x, y, and z satisfy 0≦x≦15, 0≦y≦15, and 0≦z≦50, respectively, where at least one of x and y is not 0.

11. The nonaqueous electrolyte battery of claim 8, wherein the nonaqueous solvent contains at least one of the cyclic carbonate esters of the following formulae (VII) and (VIII), 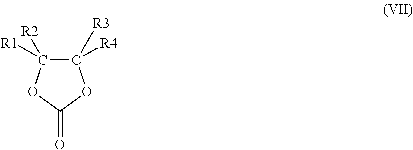
wherein R1 to R4 are hydrogen groups, halogen groups, alkyl groups, or halogenated alkyl groups, and at least one of R1 to R4 is a halogen group or a halogenated alkyl group, 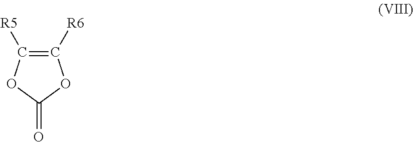
wherein R5 and R6 are hydrogen groups or alkyl groups.

12. The nonaqueous electrolyte battery of claim 8, further comprising an exterior member formed from a laminate film.
